(19) United States
(12) Patent Application Publication
(10) Pub. No.: US 2017/0031962 A1
(43) Pub. Date: Feb. 2, 2017

(54) SYSTEMS AND METHODS FOR VISUALIZING EQUIPMENT UTILIZATION IN A CENTRAL PLANT

(71) Applicant: Johnson Controls Technology Company, Holland, MI (US)

(72) Inventors: Robert D. Turney, Watertown, WI (US); Joseph Stagner, Stanford, CA (US); James P. Kummer, Wales, WI (US)

(73) Assignee: JOHNSON CONTROLS TECHNOLOGY COMPANY, Holland, MI (US)

(21) Appl. No.: 14/815,845

(22) Filed: Jul. 31, 2015

(51) Int. Cl. G06F 17/30; G05B 15/02; G05D 23/19; G06F 3/0484

(52) U.S. Cl. CPC G06F 17/30312; G06F 3/0484; G06F 17/3056; G05B 15/02; G05D 23/1917

(57) ABSTRACT

A system for visualizing equipment utilization in a central plant includes a subplant monitor, a subplant utilization database, and a dispatch graphical user interface (GUI) generator. The subplant monitor receives subplant utilization data including an indication of a thermal energy load served by each of a plurality of subplants of the central plant. The subplant utilization database stores the subplant utilization data for each of a plurality of time steps. The dispatch GUI generator generates a dispatch GUI using the subplant utilization data. The dispatch GUI includes an indication of the thermal energy load served by each of the plurality of subplants for each of the plurality of time steps. The dispatch GUI may include a set of stacked bars for each of the time steps. Each of the stacked bars may represent the thermal energy load served by one of the subplants during a corresponding time step.

### BACKGROUND

The present invention relates generally to a central plant that includes a plurality of subplants configured to serve thermal energy loads. The present invention relates more particularly to systems and methods for visualizing the actual and predicted utilization of each of the plurality of subplants of a central plant.

A central plant may include a plurality of subplants configured to serve the heating and cooling loads of a building or campus. For example, the central plant may include a heater subplant, a chiller subplant, a heat recovery chiller subplant, a hot thermal energy storage (TES) subplant, and/or a cold TES subplant. The subplants may include a variety of HVAC equipment configured to serve heating and cooling loads (e.g., heaters, chillers, heat recovery chillers, cooling towers, etc.). The central plant may be controlled by a central plant controller that distributes a requested or predicted thermal energy load (e.g., a heating load or a cooling load) across the plurality of subplants. It can be difficult and challenging to visualize subplant utilization over time.

### SUMMARY

One implementation of the present disclosure is a system for visualizing equipment utilization in a central plant. The central plant has a plurality of subplants configured to serve thermal energy loads. The system includes a subplant monitor that receives subplant utilization data comprising an indication of a thermal energy load served by each of the plurality of subplants. The system further includes a subplant utilization database that receives the subplant utilization data from the subplant monitor and stores the subplant utilization data for each of a plurality of time steps. The system further includes a dispatch graphical user interface (GUI) generator that retrieves the subplant utilization data from the subplant utilization database and generates a dispatch GUI using the subplant utilization data. The dispatch GUI includes an indication of the thermal energy load served by each of the plurality of subplants for each of the plurality of time steps. In some embodiments, the dispatch GUI generator causes the dispatch GUI to be displayed via a user interface of a client device.

In some embodiments, the dispatch GUI includes a set of stacked bars for each of the time steps. Each of the stacked bars may represent the thermal energy load served by one of the subplants during a corresponding time step and may have a size based on a magnitude of the thermal energy load. In some embodiments, the thermal energy load includes at least one of a heating load and a cooling load.

In some embodiments, the dispatch GUI includes a requested load line representing a total thermal energy load requested to be served by the plurality of subplants during each of the time steps. The dispatch GUI may include an excess load value indicating an amount by which a combined magnitude of the thermal energy loads represented by the stacked bars for a time step exceeds the requested thermal energy load for the time step.

In some embodiments, the dispatch GUI includes a zero line, a first set of stacked bars, and a second set of stacked bars. The first set of stacked bars may extend in a first direction from the zero line. Each of the first set of stacked bars may represent a cooling load served by a corresponding subplant configured to serve cooling loads. The second set of stacked bars may extend in a second direction from the zero line opposite the first direction. Each of the second set of stacked bars may represent a heating load served by a corresponding subplant configured to serve heating loads.

In some embodiments, the subplant utilization data includes actual subplant utilization data and predicted subplant utilization data. The actual subplant utilization data may include an indication of a past or current thermal energy load served by each of the plurality of subplants. The predicted subplant utilization data may include a prediction of future thermal energy loads served by each of the plurality of subplants.

In some embodiments, the plurality of time steps include past time steps and future time steps. The subplant utilization database may store the actual subplant utilization data for the past time steps and stores the predicted subplant utilization data for the future time steps.

In some embodiments, the subplant utilization database receives a new prediction of the future thermal energy loads served by each of the plurality of subplants and updates the stored subplant utilization data with the new prediction of the future thermal energy loads.

In some embodiments, the plurality of subplants include a thermal energy storage subplant that stores thermal energy produced by other of the subplants and serves the thermal energy load by discharging the stored thermal energy. The dispatch GUI may include a thermal energy storage line representing a charge state for the thermal energy storage subplant during each of the time steps.

Another implementation of the present disclosure is a method for visualizing equipment utilization in a central plant. The central plant has a plurality of subplants configured to serve thermal energy loads. The method includes receiving subplant utilization data including an indication of a thermal energy load served by each of the plurality of subplants. The method further includes storing, in a subplant utilization database, the subplant utilization data for each of a plurality of time steps. The method further includes generating a dispatch graphical user interface (GUI) using the subplant utilization data. The dispatch GUI includes an indication of the thermal energy load served by each of the plurality of subplants for each of the plurality of time steps. In some embodiments, the method includes causing the dispatch GUI to be displayed via a user interface of a client device.

In some embodiments, the dispatch GUI includes a set of stacked bars for each of the time steps. Each of the stacked bars may represent the thermal energy load served by one of the subplants during a corresponding time step and may have a size based on a magnitude of the thermal energy load. In some embodiments, the thermal energy load includes at least one of a heating load and a cooling load.

In some embodiments, the dispatch GUI includes a requested load line representing a total thermal energy load requested to be served by the plurality of subplants during each of the time steps. The dispatch GUI may include an excess load value indicating an amount by which a combined magnitude of the thermal energy loads represented by the stacked bars for a time step exceeds the requested thermal energy load for the time step.

In some embodiments, the dispatch GUI includes a zero line, a first set of stacked bars, and a second set of stacked bars. The first set of stacked bars may extend in a first direction from the zero line. Each of the first set of stacked bars may represent a cooling load served by a corresponding subplant configured to serve cooling loads. The second set of stacked bars may extend in a second direction from the zero line opposite the first direction. Each of the second set of stacked bars may represent a heating load served by a corresponding subplant configured to serve heating loads.

In some embodiments, the subplant utilization data includes actual subplant utilization data and predicted subplant utilization data. The actual subplant utilization data may include an indication of a past or current thermal energy load served by each of the plurality of subplants. The predicted subplant utilization data may include a prediction of future thermal energy loads served by each of the plurality of subplants.

In some embodiments, the plurality of time steps comprise past time steps and future time steps. Storing the subplant utilization data may include storing the actual subplant utilization data for the past time steps and stores the predicted subplant utilization data for the future time steps.

In some embodiments, the method includes receiving a new prediction of the future thermal energy loads served by each of the plurality of subplants and updating the stored subplant utilization data with the new prediction of the future thermal energy loads.

In some embodiments, the plurality of subplants include a thermal energy storage subplant that stores thermal energy produced by other of the subplants and serves the thermal energy load by discharging the stored thermal energy. The dispatch GUI may include a thermal energy storage line representing a charge state for the thermal energy storage subplant during each of the time steps.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a drawing of a building equipped with a building automation system and served by a central plant, according to an exemplary embodiment.

FIG. 2 is a schematic diagram of a central plant including a plurality of subplants configured to serve the heating and cooling loads of the building of FIG. 1, according to an exemplary embodiment.

FIG. 3 is a block diagram of a central plant controller configured to control the central plant of FIG. 2 and to predict the loads on each of the subplants, according to an exemplary embodiment.

FIG. 4 is a block diagram of a central plant system illustrating a cascaded optimization process which may be performed by the central plant controller of FIG. 3 to predict the subplant loads, according to an exemplary embodiment.

FIG. 5 is a block diagram of a system for visualizing equipment utilization in a central plant including a dispatch graphical user interface (GUI) generator configured to generate a dispatch GUI, according to an exemplary embodiment.

FIGS. 6A-6D are graphs of a dispatch GUI which may be generated by the dispatch GUI generator of FIG. 5 to illustrate the past, current, and future subplant loads and to provide other information relevant to the operation of the central plant, according to an exemplary embodiment.

FIGS. 7A-7G are graphs of another dispatch GUI which may be generated by the dispatch GUI generator of FIG. 5 to illustrate the past, current, and future subplant loads and to provide other information relevant to the operation of the central plant, according to an exemplary embodiment.

FIG. 8 is a flowchart of a process for visualizing equipment utilization in a central plant, according to an exemplary embodiment.

### DETAILED DESCRIPTION

Referring generally to the FIGURES, systems and methods for visualizing equipment utilization in a central plant are shown, according to an exemplary embodiment. The central plant may include a plurality of subplants configured to serve the heating and cooling loads of a building or campus. For example, the central plant may include a heater subplant, a chiller subplant, a heat recovery chiller subplant, a hot thermal energy storage (TES) subplant, and/or a cold TES subplant. The central plant may be controlled by a central plant controller that distributes a requested or predicted thermal energy load (e.g., a heating load or a cooling load) across the plurality of subplants. In some embodiments, the central plant controller performs an optimization process to determine an optimal load distribution across the plurality of subplants for each of a plurality of time steps within a prediction window.

The central plant controller may predict the loads on each of the subplants throughout the prediction window. In some embodiments, the predicted subplant loads include a heating load served by the heating subplant, a heating load served by the heat recovery chiller subplant, a cooling load served by the heat recovery chiller subplant, a cooling load served by the chiller subplant, a heating load served or stored by the hot TES subplant (e.g., a predicted rate at which the hot TES subplant will be charging or discharging), and/or a cooling load served or stored by the cold TES subplant (e.g., a predicted rate at which the cold TES subplant will be charging or discharging). In some embodiments, the central plant controller predicts a charge state for the TES subplants defining an amount of thermal energy stored in each of the TES subplants during each of the time steps. The predicted subplant loads and TES charge states for each of the future time steps may be stored in a subplant utilization database. The actual operation of central plant may be monitored to determine the actual subplant loads and TES charge stages during each of the time steps. The actual subplant loads and TES charge states may be stored in the subplant utilization database for each of the past and current time steps.

A dispatch graphical user interface (GUI) generator may access the data stored in the subplant utilization database and use the stored data to generate a dispatch GUI. The dispatch GUI may be a graph or chart that illustrates the actual subplant utilization data (e.g., past and current subplant loads) and the predicted subplant utilization data (e.g., future subplant loads) in a graphical format. In some embodiments, the dispatch GUI indicates the actual and predicted subplant loads for each of the subplants at each of the time steps represented in the dispatch GUI.

The dispatch GUI generator may provide the dispatch GUI to a user interface of a client device (e.g., a computer terminal, a workstation, a laptop, a tablet, a smartphone, etc.). In some embodiments, the dispatch GUI generator is a component of the central plant controller. In other embodiments, the dispatch GUI generator may be a component of the client device. For example, the dispatch GUI generator may be a web browser or a specialized application running on the client device. In some embodiments, the dispatch GUI is rendered using specialized viewing software (e.g., a central plant monitoring application) installed on the client device. In other embodiments, the dispatch GUI is provided via a web interface which allows the dispatch GUI to be rendered and viewed using a web browser without requiring any specialized applications or software to be installed on the client device.

The dispatch GUI may include a set of stacked bars for each of the time steps. Each of the stacked bars may represent the thermal energy load served by one of the subplants during a corresponding time step and may have a size based on a magnitude of the thermal energy load. In some embodiments, the dispatch GUI includes a requested load line representing a total thermal energy load requested to be served by the plurality of subplants during each of the time steps. In some embodiments, the dispatch GUI includes an excess load value indicating an amount by which a combined magnitude of the thermal energy loads represented by the stacked bars for a time step exceeds the requested thermal energy load for the time step.

In some embodiments, the dispatch GUI includes a zero line, a first set of stacked bars, and a second set of stacked bars. The first set of stacked bars may extend in a first direction from the zero line. Each of the first set of stacked bars may represent a cooling load served by a corresponding subplant configured to serve cooling loads. The second set of stacked bars may extend in a second direction from the zero line opposite the first direction. Each of the second set of stacked bars may represent a heating load served by a corresponding subplant configured to serve heating loads. Additional features and advantages of the dispatch GUI are described in greater detail below.

Building with HVAC System

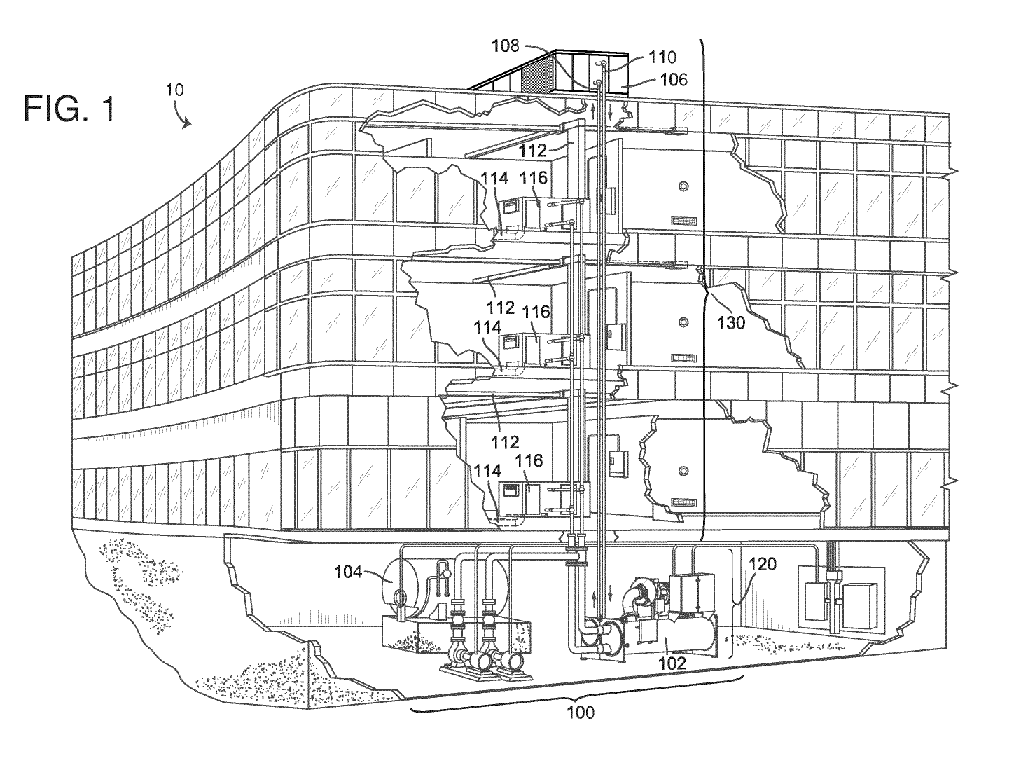

Referring now to FIG. 1, a perspective view of a building 10 is shown. Building 10 is served by a building automation system (BAS). A BAS is, in general, a system of devices configured to control, monitor, and manage equipment in or around a building or building area. A BAS can include, for example, a HVAC system, a security system, a lighting system, a fire alerting system, any other system that is capable of managing building functions or devices, or any combination thereof.

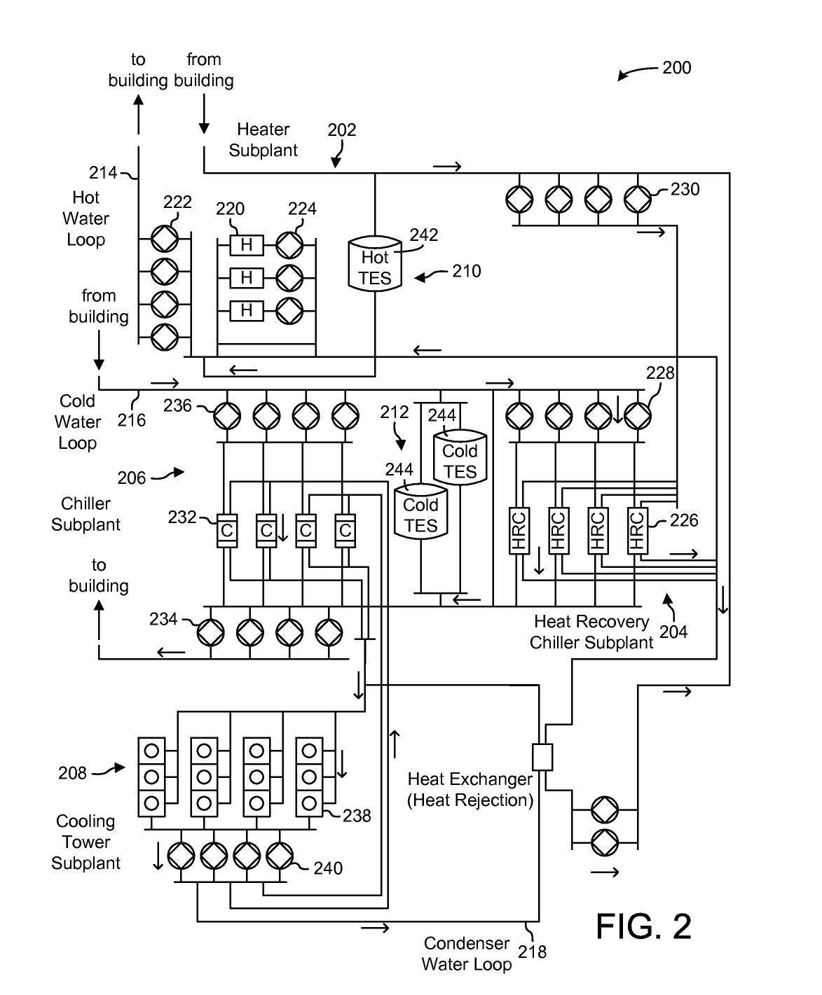

The BAS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. In some embodiments, waterside system 120 is replaced with a central energy plant such as central plant 200, described with reference to FIG. 2.

Still referring to FIG. 1, HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Central Plant and Control System

Referring now to FIG. 2, a block diagram of a central plant 200 is shown, according to an exemplary embodiment. In brief overview, central plant 200 may include various types of equipment configured to serve the thermal energy loads of a building or campus (i.e., a system of buildings). For example, central plant 200 may include heaters, chillers, heat recovery chillers, cooling towers, or other types of equipment configured to serve the heating and/or cooling loads of a building or campus. Central plant 200 may consume resources from a utility (e.g., electricity, water, natural gas, etc.) to heat or cool a working fluid that is circulated to one or more buildings or stored for later use (e.g., in thermal energy storage tanks) to provide heating or cooling for the buildings. In various embodiments, central plant 200 may supplement or replace waterside system 120 in building 10 or may be implemented separate from building 10 (e.g., at an offsite location).

Central plant 200 is shown to include a plurality of subplants 202-212 including a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO₂, etc.) may be used in place of or in addition to water to serve the thermal energy loads. In other embodiments, subplants 202-212 may provide heating and/or cooling directly to the building or campus without requiring an intermediate heat transfer fluid. These and other variations to central plant 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in central plant 200 (e.g., pumps 222, 224, 228, 230, 234, 236, and/or 240) or pipelines in central plant 200 include an isolation valve associated therewith. Isolation valves may be integrated with the pumps or positioned upstream or downstream of the pumps to control the fluid flows in central plant 200. In various embodiments, central plant 200 may include more, fewer, or different types of devices and/or subplants based on the particular configuration of central plant 200 and the types of loads served by central plant 200.

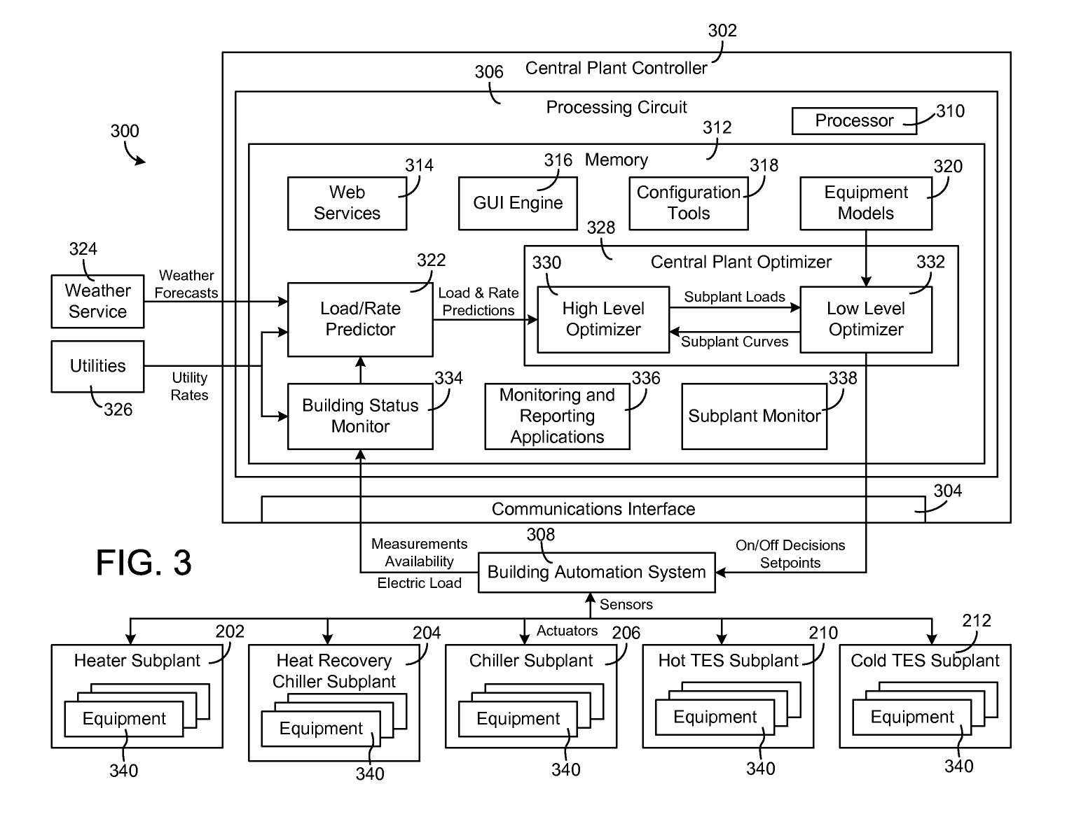

Referring now to FIG. 3, a block diagram illustrating a central plant system 300 is shown, according to an exemplary embodiment. System 300 is shown to include a central plant controller 302, a building automation system (BAS) 308, and a plurality of subplants 202-212. Subplants 202-212 may be the same as previously described with reference to FIG. 2. For example, subplants 202-212 are shown to include a heater subplant 202, a heat recovery chiller subplant 204, a chiller subplant 206, a hot TES subplant 210, and a cold TES subplant 212.

Each of subplants 202-212 is shown to include equipment 340 that can be controlled by central plant controller 302 and/or building automation system 308 to optimize the performance of central plant 200. Equipment 340 may include, for example, heating devices 220, chillers 232, heat recovery heat exchangers 226, cooling towers 238, thermal energy storage devices 242-244, pumps, valves, and/or other devices of subplants 202-212. Individual devices of equipment 340 can be turned on or off to adjust the thermal energy load served by each of subplants 202-212. In some embodiments, individual devices of equipment 340 can be operated at variable capacities (e.g., operating a chiller at 10% capacity or 60% capacity) according to an operating setpoint received from central plant controller 302.

In some embodiments, one or more of subplants 202-212 includes a subplant level controller configured to control the equipment 340 of the corresponding subplant. For example, central plant controller 302 may determine an on/off configuration and global operating setpoints for equipment 340. In response to the on/off configuration and received global operating setpoints, the subplant controllers may turn individual devices of equipment 340 on or off, and implement specific operating setpoints (e.g., damper position, vane position, fan speed, pump speed, etc.) to reach or maintain the global operating setpoints.

In some embodiments, the subplant level controllers receive subplant load setpoints from central plant controller 302. Each subplant level controller may use the subplant load setpoint for the corresponding subplant to select one or more devices of the equipment 340 within the subplant to activate or deactivate in order to meet the subplant load setpoint in an energy-efficient manner. In other embodiments, the equipment selection and staging decisions (i.e., deciding which devices to turn on/off) are performed by a low level optimizer 332 within central plant controller 302.

BAS 308 may be configured to monitor conditions within a controlled building or building zone. For example, BAS 308 may receive input from various sensors (e.g., temperature sensors, humidity sensors, airflow sensors, voltage sensors, etc.) distributed throughout the building and may report building conditions to central plant controller 302. Building conditions may include, for example, a temperature of the building or a zone of the building, a power consumption (e.g., electric load) of the building, a state of one or more actuators configured to affect a controlled state within the building, or other types of information relating to the controlled building. BAS 308 may operate subplants 202-212 to affect the monitored conditions within the building and/or to serve the thermal energy loads of the building.

BAS 308 may receive control signals from central plant controller 302 specifying on/off states and/or setpoints for equipment 340. BAS 308 may control equipment 340 (e.g., via actuators, power relays, etc.) in accordance with the control signals provided by central plant controller 302. For example, BAS 308 may operate equipment 340 using closed loop control to achieve the setpoints specified by central plant controller 302. In various embodiments, BAS 308 may be combined with central plant controller 302 or may be part of a separate building automation system. According to an exemplary embodiment, BAS 308 is a METASYS® brand building automation system, as sold by Johnson Controls, Inc.

Central plant controller 302 may monitor the status of the controlled building using information received from BAS 308. Central plant controller 302 may be configured to predict the thermal energy loads (e.g., heating loads, cooling loads, etc.) of the building for plurality of time steps in a prediction window (e.g., using weather forecasts from a weather service 324). Central plant controller 302 may generate on/off decisions and/or setpoints for equipment 340 to minimize the cost of energy consumed by subplants 202-212 to serve the predicted heating and/or cooling loads for the duration of the prediction window. According to an exemplary embodiment, central plant controller 302 is integrated within a single computer (e.g., one server, one housing, etc.). In various other exemplary embodiments, central plant controller 302 can be distributed across multiple servers or computers (e.g., that can exist in distributed locations). In another exemplary embodiment, central plant controller 302 is integrated with a smart building manager that manages multiple building systems and/or combined with BAS 308.

Central plant controller 302 is shown to include a communications interface 304 and a processing circuit 306. Communications interface 304 may include wired or wireless interfaces (e.g., jacks, antennas, transmitters, receivers, transceivers, wire terminals, etc.) for conducting data communications with various systems, devices, or networks. For example, communications interface 304 may include an Ethernet card and port for sending and receiving data via an Ethernet-based communications network and/or a WiFi transceiver for communicating via a wireless communications network. Communications interface 304 may be configured to communicate via local area networks or wide area networks (e.g., the Internet, a building WAN, etc.) and may use a variety of communications protocols (e.g., BACnet, IP, LON, etc.).

Communications interface 304 may be a network interface configured to facilitate electronic data communications between central plant controller 302 and various external systems or devices (e.g., BAS 308, subplants 202-212, etc.). For example, central plant controller 302 may receive information from BAS 308 indicating one or more measured states of the controlled building (e.g., temperature, humidity, electric loads, etc.) and one or more states of subplants 202-212 (e.g., equipment status, power consumption, equipment availability, etc.). Communications interface 304 may receive inputs from BAS 308 and/or subplants 202-212 and may provide operating parameters (e.g., on/off decisions, setpoints, etc.) to subplants 202-212 via BAS 308. The operating parameters may cause subplants 202-212 to activate, deactivate, or adjust a setpoint for various devices of equipment 340.

Still referring to FIG. 3, processing circuit 306 is shown to include a processor 310 and memory 312. Processor 310 may be a general purpose or specific purpose processor, an application specific integrated circuit (ASIC), one or more field programmable gate arrays (FPGAs), a group of processing components, or other suitable processing components. Processor 310 may be configured to execute computer code or instructions stored in memory 312 or received from other computer readable media (e.g., CDROM, network storage, a remote server, etc.).

Memory 312 may include one or more devices (e.g., memory units, memory devices, storage devices, etc.) for storing data and/or computer code for completing and/or facilitating the various processes described in the present disclosure. Memory 312 may include random access memory (RAM), read-only memory (ROM), hard drive storage, temporary storage, non-volatile memory, flash memory, optical memory, or any other suitable memory for storing software objects and/or computer instructions. Memory 312 may include database components, object code components, script components, or any other type of information structure for supporting the various activities and information structures described in the present disclosure. Memory 312 may be communicably connected to processor 310 via processing circuit 306 and may include computer code for executing (e.g., by processor 310) one or more processes described herein.

Still referring to FIG. 3, memory 312 is shown to include a building status monitor 334. Central plant controller 302 may receive data regarding the overall building or building space to be heated or cooled with central plant 200 via building status monitor 334. In an exemplary embodiment, building status monitor 334 may include a graphical user interface component configured to provide graphical user interfaces to a user for selecting building requirements (e.g., overall temperature parameters, selecting schedules for the building, selecting different temperature levels for different building zones, etc.).

Central plant controller 302 may determine on/off configurations and operating setpoints to satisfy the building requirements received from building status monitor 334. In some embodiments, building status monitor 334 receives, collects, stores, and/or transmits cooling load requirements, building temperature setpoints, occupancy data, weather data, energy data, schedule data, and other building parameters. In some embodiments, building status monitor 334 stores data regarding energy costs, such as pricing information available from utilities 326 (energy charge, demand charge, etc.).

Still referring to FIG. 3, memory 312 is shown to include a load/rate predictor 322. Load/rate predictor 322 may be configured to predict the thermal energy loads (\hat{l}ₖ) of the building or campus for each time step k (e.g., k=1 . . . n) of an optimization period. Load/rate predictor 322 is shown receiving weather forecasts from a weather service 324. In some embodiments, load/rate predictor 322 predicts the thermal energy loads \hat{l}ₖ as a function of the weather forecasts. In some embodiments, load/rate predictor 322 uses feedback from BAS 308 to predict loads \hat{l}ₖ. Feedback from BAS 308 may include various types of sensory inputs (e.g., temperature, flow, humidity, enthalpy, etc.) or other data relating to the controlled building (e.g., inputs from a HVAC system, a lighting control system, a security system, a water system, etc.).

In some embodiments, load/rate predictor 322 receives a measured electric load and/or previous measured load data from BAS 308 (e.g., via building status monitor 334). Load/rate predictor 322 may predict loads \hat{l}ₖ as a function of a given weather forecast (\hat{φ}_{w}), a day type (day), the time of day (t), and previous measured load data (Yₖ₋₁). Such a relationship is expressed in the following equation:

\hat{l}ₖ=ƒ(\hat{φ}_{w},day,t|Yₖ₋₁)

In some embodiments, load/rate predictor 322 uses a deterministic plus stochastic model trained from historical load data to predict loads \hat{l}ₖ. Load/rate predictor 322 may use any of a variety of prediction methods to predict loads \hat{l}ₖ (e.g., linear regression for the deterministic portion and an AR model for the stochastic portion). Load/rate predictor 322 may predict one or more different types of loads for the building or campus. For example, load/rate predictor 322 may predict a hot water load \hat{l}_{Hot,k} and a cold water load \hat{l}_{Cold,k} for each time step k within the prediction window.

Load/rate predictor 322 is shown receiving utility rates from utilities 326. Utility rates may indicate a cost or price per unit of a resource (e.g., electricity, natural gas, water, etc.) provided by utilities 326 at each time step k in the prediction window. In some embodiments, the utility rates are time-variable rates. For example, the price of electricity may be higher at certain times of day or days of the week (e.g., during high demand periods) and lower at other times of day or days of the week (e.g., during low demand periods). The utility rates may define various time periods and a cost per unit of a resource during each time period. Utility rates may be actual rates received from utilities 326 or predicted utility rates estimated by load/rate predictor 322.

In some embodiments, the utility rates include demand charges for one or more resources provided by utilities 326. A demand charge may define a separate cost imposed by utilities 326 based on the maximum usage of a particular resource (e.g., maximum energy consumption) during a demand charge period. The utility rates may define various demand charge periods and one or more demand charges associated with each demand charge period. In some instances, demand charge periods may overlap partially or completely with each other and/or with the prediction window. Advantageously, central plant optimizer 328 may be configured to account for demand charges in the high level optimization process performed by high level optimizer 330. Utilities 326 may be defined by time-variable (e.g., hourly) prices, a maximum service level (e.g., a maximum rate of consumption allowed by the physical infrastructure or by contract) and, in the case of electricity, a demand charge or a charge for the peak rate of consumption within a certain period.

Load/rate predictor 322 may store the predicted loads \hat{l}ₖ and the utility rates in memory 312 and/or provide the predicted loads \hat{l}ₖ and the utility rates to central plant optimizer 328. Central plant optimizer 328 may use the predicted loads \hat{l}ₖ and the utility rates to determine an optimal load distribution for subplants 202-212 and to generate on/off decisions and setpoints for equipment 340.

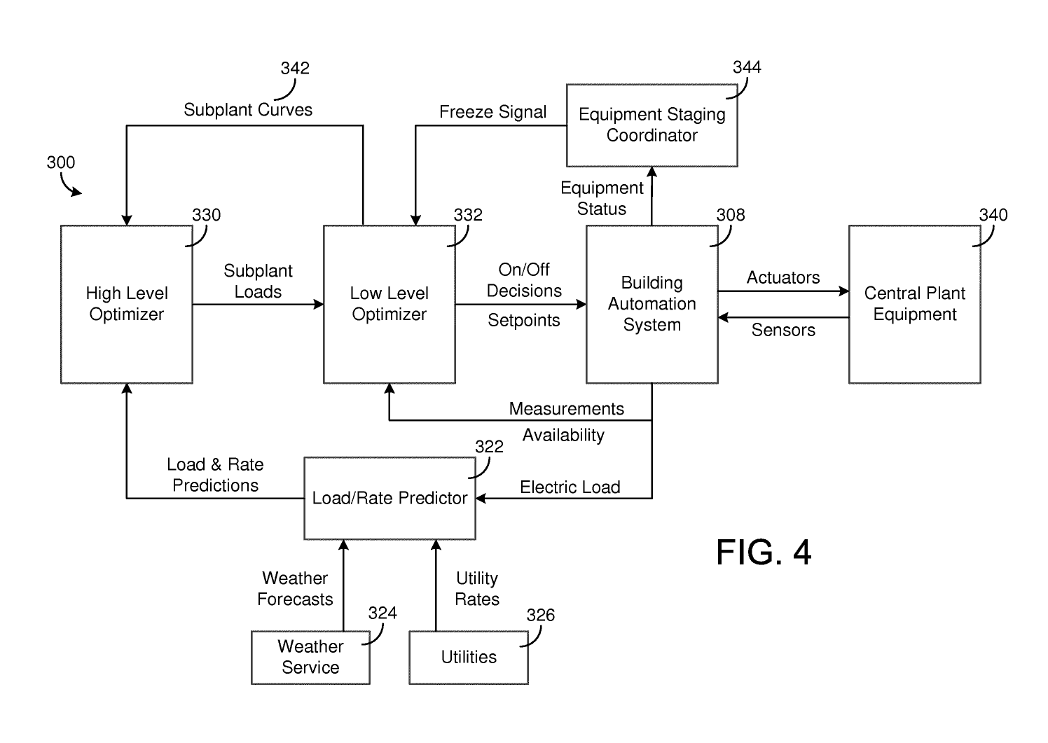

Still referring to FIG. 3, memory 312 is shown to include an central plant optimizer 328. Central plant optimizer 328 may perform a cascaded optimization process to optimize the performance of central plant 200. For example, central plant optimizer 328 is shown to include a high level optimizer 330 and a low level optimizer 332. High level optimizer 330 may control an outer (e.g., subplant level) loop of the cascaded optimization. High level optimizer 330 may determine an optimal distribution of thermal energy loads across subplants 202-212 for each time step in the prediction window in order to optimize (e.g., minimize) the cost of energy consumed by subplants 202-212. Low level optimizer 332 may control an inner (e.g., equipment level) loop of the cascaded optimization. Low level optimizer 332 may determine how to best run each subplant at the load setpoint determined by high level optimizer 330. For example, low level optimizer 332 may determine on/off states and/or operating setpoints for various devices of equipment 340 in order to optimize (e.g., minimize) the energy consumption of each subplant while meeting the thermal energy load setpoint for the subplant. The cascaded optimization process is described in greater detail with reference to FIG. 4.

Still referring to FIG. 3, memory 312 is shown to include a subplant monitor 338. Subplant monitor 338 may collect and store information regarding the past, current, and future (e.g., planned) utilization of subplants 202-212. For example, subplant monitor 338 may receive actual utilization data from BAS 308 and/or central plant 200 indicating the actual thermal energy loads served by heater subplant 202, heat recovery chiller subplant 204, and chiller subplant 206. The actual utilization data may be current utilization data (e.g., the actual thermal energy loads currently being served) or past utilization data (e.g., the actual thermal energy loads served at a previous time). The actual utilization data may also indicate the past or current charging or discharging rates for hot TES subplant 210 and cold TES subplant 212 and the past or current status (i.e., storage level) of TES subplants 210-212. In some embodiments, the actual utilization data indicates a total heating load and/or a total cooling load requested to be served by central plant 200 at a past or current time. The actual utilization data may also indicate any unmet heating and/or cooling load that is requested but not met by central plant 200 at a past or current time. In some embodiments, the actual utilization data indicates a past or current rate of utility consumption (e.g., water consumption, electricity consumption, natural gas consumption, photovoltaic energy consumption, etc.).

The actual utilization data may be provided at various levels of granularity. For example, the actual utilization data for a given subplant (e.g., chiller subplant 206) may include an aggregate value that represents the total thermal energy load served by the subplant (e.g., the total load served by all of chillers 232). In other embodiments, the actual utilization data may be provided for each of the individual devices within subplants 202-212 (e.g., the cooling load served by each of chillers 232 individually).

In some embodiments, subplant monitor 338 receives the actual utilization data as a continuous data signal. In other embodiments, subplant monitor 338 receives the actual utilization data at regular intervals (e.g., every minute, every fifteen minutes, every hour, etc.). Subplant monitor 338 may store the actual utilization data in memory 312 or in a separate subplant utilization database. In some embodiments, subplant monitor 338 stores the actual utilization data at regular intervals such that the stored utilization data represents a history of the relevant operating information for central plant 200 over time.

Subplant monitor 338 may receive predicted future utilization data indicating the thermal energy loads to be served by heater subplant 202, heat recovery chiller subplant 204, and chiller subplant 206 at a future time. The predicted utilization data may also indicate the predicted charging or discharging rates for hot TES subplant 210 and cold TES subplant 212 and the predicted status (i.e., storage level) of TES subplants 210-212 at a future time. In some embodiments, the predicted utilization data for subplants 202-212 is generated by central plant optimizer 328 for multiple time steps during a prediction window. For example, the predicted utilization data may include the optimal subplant loads predicted by high level optimizer 330 and/or the optimal equipment on/off states predicted by low level optimizer 332 for each time step during the prediction window.

In some embodiments, the predicted utilization data indicates a total heating load and/or a total cooling load predicted by load/rate predictor 322. The predicted utilization data may also indicate any unmet heating and/or cooling load that is predicted to be requested but not met by central plant 200. In some embodiments, the predicted utilization data indicates a predicted rate of utility consumption (e.g., water consumption, electricity consumption, natural gas consumption, photovoltaic energy consumption, etc.).

The predicted utilization data may be provided at various levels of granularity. For example, the predicted utilization data for a given subplant (e.g., chiller subplant 206) may include an aggregate value that represents the total thermal energy load estimated to be served by the subplant (e.g., the total predicted load served by all of chillers 232). In other embodiments, the predicted utilization data may be provided for each of the individual devices within subplants 202-212 (e.g., the predicted cooling load served by each of chillers 232 individually).

In some embodiments, subplant monitor 338 receives the predicted utilization data for each of a plurality of time steps during a prediction window. For example, central plant optimizer 328 may perform an optimization process (described in greater detail with reference to FIG. 4) to generate subplant load values for each time step during a prediction window that extends from the current time to a predetermined prediction horizon. Each time step may have a defined duration (e.g., fifteen minutes, one hour, etc.). The predicted subplant load values may be updated each time the optimization process is performed. Subplant monitor 338 may store the predicted utilization data in memory 312 or in a separate subplant utilization database. In some embodiments, subplant monitor 338 stores the predicted utilization data at regular intervals (e.g., hourly intervals) such that the stored utilization data represents a planned dispatch schedule for central plant 200 over time.

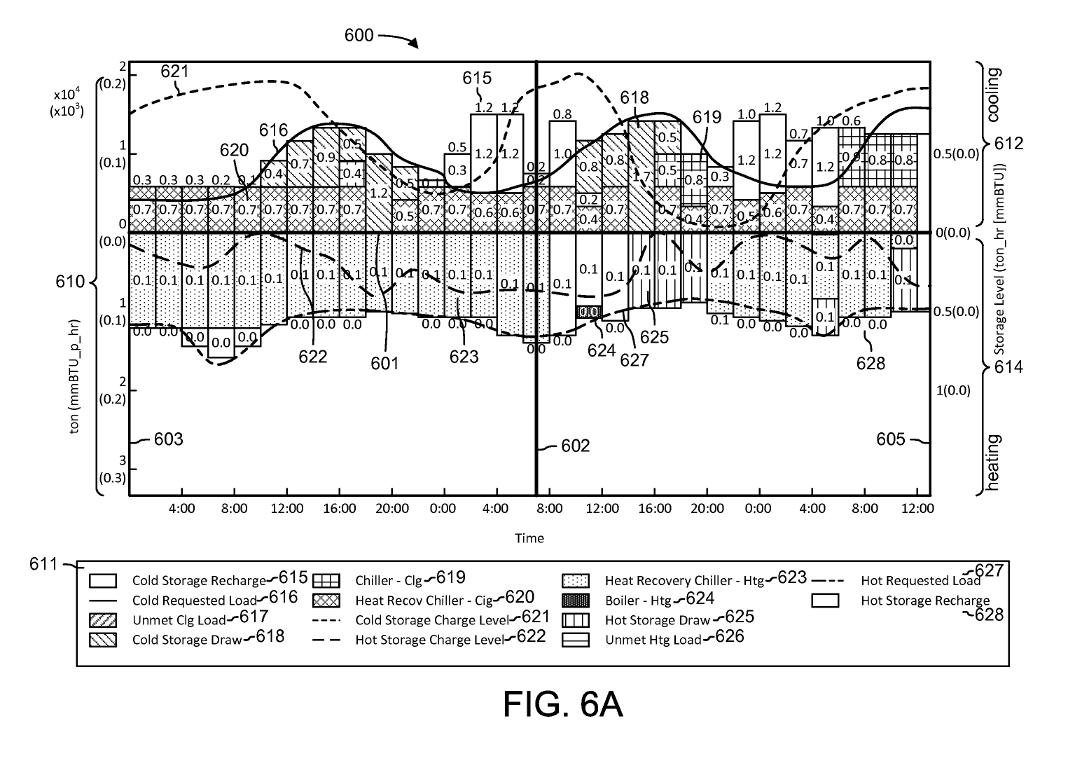

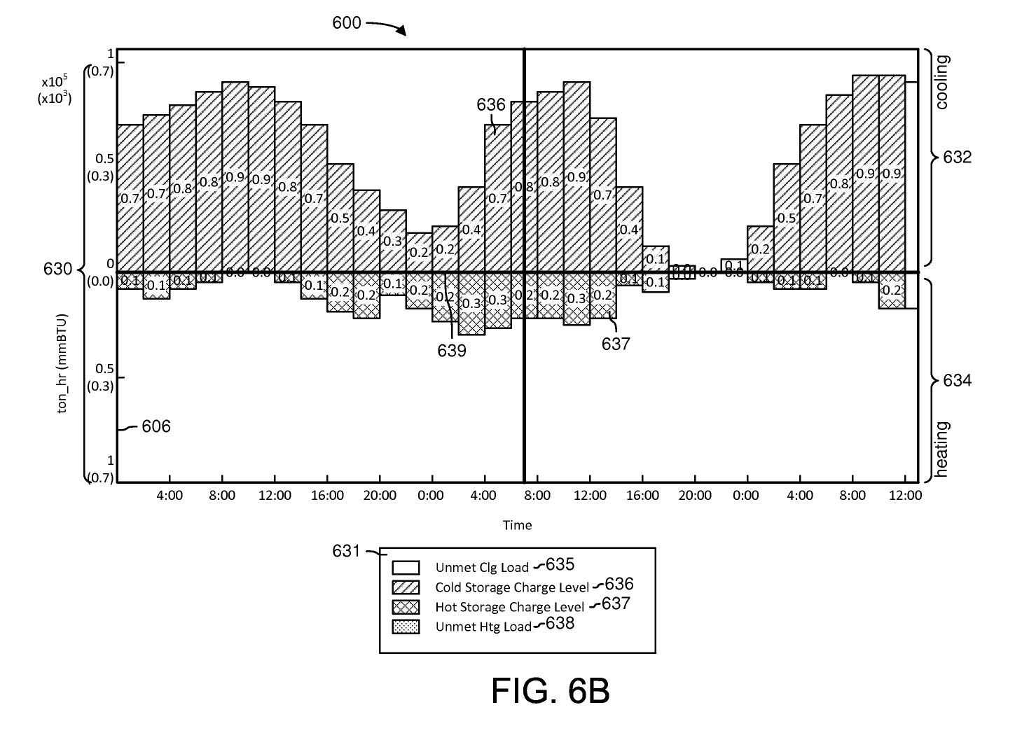

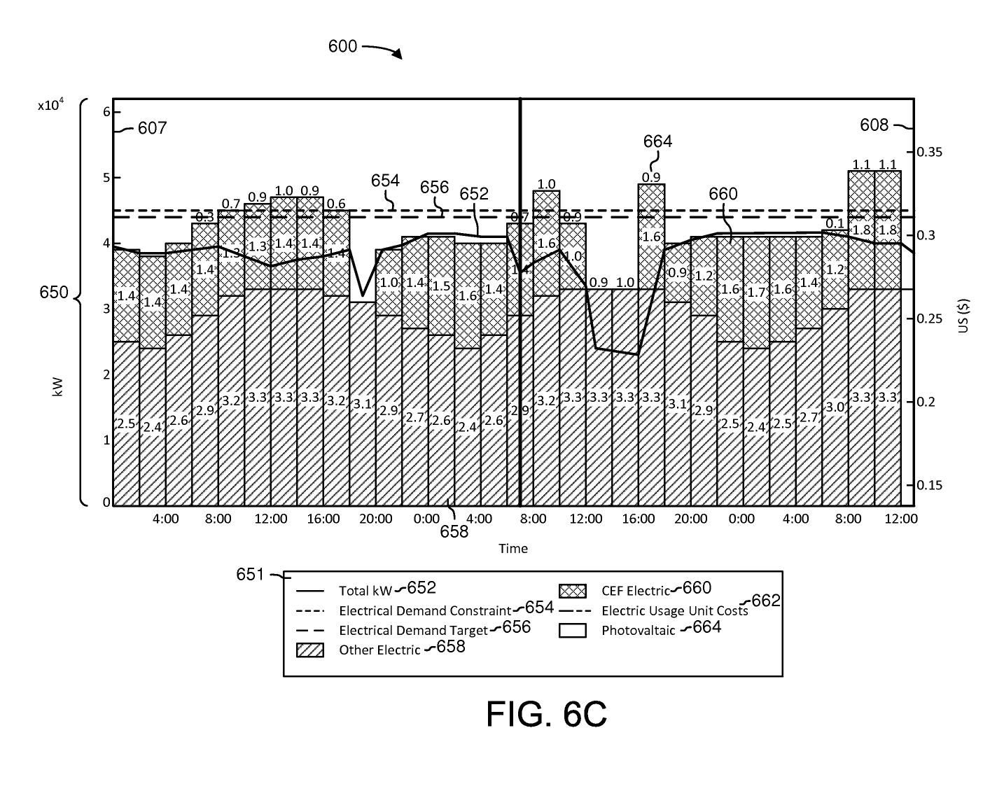

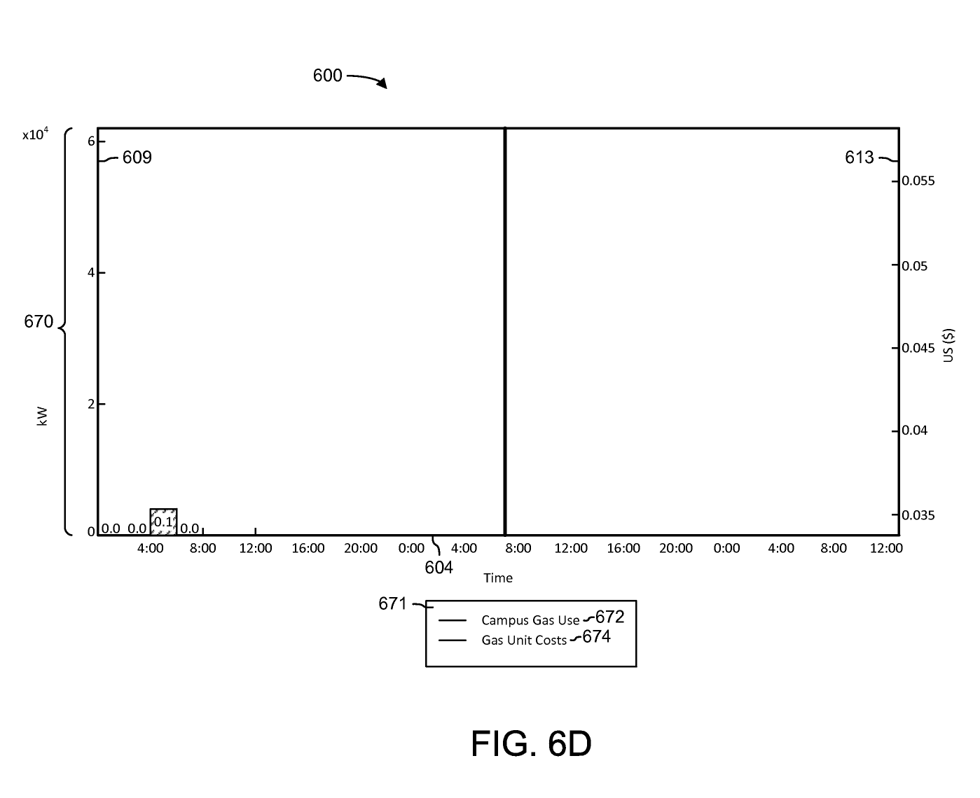

Data and processing results from central plant optimizer 328, subplant monitor 338, or other modules of central plant controller 302 may be accessed by (or pushed to) monitoring and reporting applications 336. Monitoring and reporting applications 336 may be configured to generate real time system health dashboards that can be viewed and navigated by a user (e.g., a central plant engineer). For example, monitoring and reporting applications 336 may include a web-based monitoring application with several graphical user interface (GUI) elements (e.g., widgets, dashboard controls, windows, etc.) for displaying key performance indicators (KPI) or other information to users of a GUI. In some embodiments, the GUI elements include a chart or graph (e.g., a dispatch bar chart) that represents the actual and predicted utilization data provided by subplant monitor 338. GUI elements or reports may be generated and shown based on actual and predicted utilization data that allow users to monitor the performance of subplants 202-212 and central plant 200 as a whole using a single screen. An exemplary dispatch GUI that may be generated by monitoring and reporting applications 336 is described in greater detail with reference to FIG. 6.

Still referring to FIG. 3, central plant controller 302 may include one or more GUI servers, web services 314, or GUI engines 316 to support monitoring and reporting applications 336. In various embodiments, applications 336, web services 314, and GUI engine 316 may be provided as separate components outside of central plant controller 302 (e.g., as part of a smart building manager). Central plant controller 302 may be configured to maintain detailed historical databases (e.g., relational databases, XML databases, etc.) of relevant data and includes computer code modules that continuously, frequently, or infrequently query, aggregate, transform, search, or otherwise process the data maintained in the detailed databases. Central plant controller 302 may be configured to provide the results of any such processing to other databases, tables, XML files, or other data structures for further querying, calculation, or access by, for example, external monitoring and reporting applications.

Central plant controller 302 is shown to include configuration tools 318. Configuration tools 318 can allow a user to define (e.g., via graphical user interfaces, via prompt-driven wizards, etc.) how central plant controller 302 should react to changing conditions in the central plant subsystems. In an exemplary embodiment, configuration tools 318 allow a user to build and store condition-response scenarios that can cross multiple central plant devices, multiple building systems, and multiple enterprise control applications (e.g., work order management system applications, entity resource planning applications, etc.). For example, configuration tools 318 can provide the user with the ability to combine data (e.g., from subsystems, from event histories) using a variety of conditional logic. In varying exemplary embodiments, the conditional logic can range from simple logical operators between conditions (e.g., AND, OR, XOR, etc.) to pseudo-code constructs or complex programming language functions (allowing for more complex interactions, conditional statements, loops, etc.). Configuration tools 318 can present user interfaces for building such conditional logic. The user interfaces may allow users to define policies and responses graphically. In some embodiments, the user interfaces may allow a user to select a pre-stored or pre-constructed policy and adapt it or enable it for use with their system.

Referring now to FIG. 4, a block diagram illustrating a portion of central plant system 300 in greater detail is shown, according to an exemplary embodiment. FIG. 4 illustrates the cascaded optimization process performed by central plant optimizer 328 to optimize the performance of central plant 200. In the cascaded optimization process, high level optimizer 330 performs a subplant level optimization that determines an optimal distribution of thermal energy loads across subplants 202-212 for each time step in the prediction window in order to minimize the cost of energy consumed by subplants 202-212. Low level optimizer 332 performs an equipment level optimization that determines how to best run each subplant at the subplant load setpoint determined by high level optimizer 330. For example, low level optimizer 332 may determine on/off states and/or operating setpoints for various devices of equipment 340 in order to optimize the energy consumption of each subplant while meeting the thermal energy load setpoint for the subplant.

One advantage of the cascaded optimization process performed by central plant optimizer 328 is the optimal use of computational time. For example, the subplant level optimization performed by high level optimizer 330 may use a relatively long time horizon due to the operation of the thermal energy storage. However, the equipment level optimization performed by low level optimizer 332 may use a much shorter time horizon or no time horizon at all since the low level system dynamics are relatively fast (compared to the dynamics of the thermal energy storage) and the low level control of equipment 340 may be handled by BAS 308. Such an optimal use of computational time makes it possible for central plant optimizer 328 to perform the central plant optimization in a short amount of time, allowing for real-time predictive control. For example, the short computational time enables central plant optimizer 328 to be implemented in a real-time planning tool with interactive feedback.

Another advantage of the cascaded optimization performed by central plant optimizer 328 is that the central plant optimization problem can be split into two cascaded subproblems. The cascaded configuration provides a layer of abstraction that allows high level optimizer 330 to distribute the thermal energy loads across subplants 202-212 without requiring high level optimizer 330 to know or use any details regarding the particular equipment configuration within each subplant. The interconnections between equipment 340 within each subplant may be hidden from high level optimizer 330 and handled by low level optimizer 332. For purposes of the subplant level optimization performed by high level optimizer 330, each subplant may be completely defined by one or more subplant curves 342.

Low level optimizer 332 may generate and provide subplant curves 342 to high level optimizer 330. Subplant curves 342 may indicate the rate of utility use by each of subplants 202-212 (e.g., electricity use measured in kW, water use measured in L/s, etc.) as a function of the subplant load. In some embodiments, low level optimizer 332 generates subplant curves 342 based on equipment models 320 (e.g., by combining equipment models 320 for individual devices into an aggregate curve for the subplant). Low level optimizer 332 may generate subplant curves 342 by running the low level optimization process for several different loads and weather conditions to generate multiple data points. Low level optimizer 332 may fit a curve to the data points to generate subplant curves 342. In other embodiments, low level optimizer 332 provides the data points to high level optimizer 330 and high level optimizer 330 generates the subplant curves using the data points.

High level optimizer 330 may receive the load and rate predictions from load/rate predictor 322 and the subplant curves 342 from low level optimizer 332. The load predictions may be based on weather forecasts from weather service 324 and/or information from building automation system 308 (e.g., a current electric load of the building, measurements from the building, a history of previous loads, a setpoint trajectory, etc.). The utility rate predictions may be based on utility rates received from utilities 326 and/or utility prices from another data source. High level optimizer 330 may determine the optimal load distribution for subplants 202-212 (e.g., a subplant load for each subplant) for each time step the prediction window and may provide the subplant loads as setpoints to low level optimizer 332. In some embodiments, high level optimizer 330 determines the subplant loads by minimizing the total operating cost of central plant 200 over the prediction window. In other words, given a predicted load and utility rate information from load/rate predictor 322, high level optimizer 330 may distribute the predicted load across subplants 202-212 over the optimization period to minimize operating cost.

In some instances, the optimal load distribution may include using TES subplants 210 and/or 212 to store thermal energy during a first time step for use during a later time step. Thermal energy storage may advantageously allow thermal energy to be produced and stored during a first time period when energy prices are relatively low and subsequently retrieved and used during a second time period when energy proves are relatively high. The high level optimization may be different from the low level optimization in that the high level optimization has a longer time constant due to the thermal energy storage provided by TES subplants 210-212. The high level optimization may be described by the following equation:

$${θ}_{HL}^{*} = arg {min}_{{θ}_{HL}} {J}_{HL} ( {θ}_{HL} )$$

where θ*_{HL} contains the optimal high level decisions (e.g., the optimal load for each of subplants 202-212) for the entire optimization period and J_{HL} is the high level cost function.

To find the optimal high level decisions θ*_{HL}, high level optimizer 330 may minimize the high level cost function J_{HL}. The high level cost function J_{HL} may be the sum of the economic (e.g., monetary) costs of each utility consumed by each of subplants 202-212 for the duration of the optimization period. In some embodiments, the high level cost function J_{HL} may be described using the following equation:

$${J}_{HL} ( {θ}_{HL} ) = {\sum }_{k = 1}^{{n}_{h}} {\sum }_{i = 1}^{{n}_{s}} [ {\sum }_{j = 1}^{{n}_{u}} {t}_{s} \cdot {c}_{jk} {u}_{jik} ( {θ}_{HL} ) ]$$

where nₕ is the number of time steps k in the optimization period, nₛ is the number of subplants, tₛ is the duration of a time step, cⱼₖ is the economic cost of utility j at a time step k of the optimization period, and uⱼᵢₖ is the rate of use of utility j by subplant i at time step k.

In some embodiments, the cost function J_{HL} includes an additional demand charge term such as:

$${w}_{d} {c}_{demand} {max}_{{n}_{h}} ( {u}_{elec} ( {θ}_{HL} ) , {u}_{max , ele} )$$

where w_{d} is a weighting term, c_{demand} is the demand cost, and the max( ) term selects the peak electricity use during the applicable demand charge period. Accordingly, the high level cost function J_{HL} may be described by the equation:

$${J}_{HL} ( {θ}_{HL} ) = {\sum }_{k = 1}^{{n}_{h}} {\sum }_{i = 1}^{{n}_{s}} [ {\sum }_{j = 1}^{{n}_{u}} {t}_{s} \cdot {c}_{jk} {u}_{jik} ( {θ}_{HL} ) ] + {w}_{d} {c}_{demand} {max}_{{n}_{h}} ( {u}_{elec} ( {θ}_{HL} ) , {u}_{max , ele} )$$

The decision vector θ_{HL} may be subject to several constraints. For example, the constraints may require that the subplants not operate at more than their total capacity, that the thermal storage not charge or discharge too quickly or under/over flow for the tank, and that the thermal energy loads for the building or campus are met. These restrictions may lead to both equality and inequality constraints on the high level optimization problem.

In some embodiments, the high level optimization performed by high level optimizer 330 is the same or similar to the high level optimization process described in U.S. patent application Ser. No. 14/634,609 filed Feb. 27, 2015 and titled “High Level Central Plant Optimization,” the entire disclosure of which is incorporated by reference herein. High level optimizer 330 may include some or all of the features and/or functionality of the high level optimization module described in U.S. patent application Ser. No. 14/634,609.

Still referring to FIG. 4, low level optimizer 332 may use the subplant loads determined by high level optimizer 330 to determine optimal low level decisions θ*_{LL} (e.g. binary on/off decisions, flow setpoints, temperature setpoints, etc.) for equipment 340. The low level optimization process may be performed for each of subplants 202-212. In various embodiments, the low level optimization process may be performed by centralized low level optimizer 332 that performs a separate low level optimization for each of subplants 202-212 or by a set of subplant level controllers that operate within each subplant (e.g., each subplant controller running an instance of low level optimizer 332). Low level optimizer 332 may be responsible for determining which devices of the subplant to use and/or the operating setpoints for such devices that will achieve the subplant load setpoint while minimizing energy consumption. The low level optimization may be described using the following equation:

$${θ}_{LL}^{*} = arg {min}_{{θ}_{LL}} {J}_{LL} ( {θ}_{LL} )$$

where θ*_{LL} contains the optimal low level decisions and J_{LL} is the low level cost function.

To find the optimal low level decisions θ*_{LL}, low level optimizer 332 may minimize the low level cost function J_{LL}. The low level cost function J_{LL} may represent the total energy consumption for all of equipment 340 in the applicable subplant. The low level cost function J_{LL} may be described using the following equation:

$${J}_{LL} ( {θ}_{LL} ) = {\sum }_{j = 1}^{N} {t}_{s} \cdot {b}_{j} {u}_{j} ( {θ}_{LL} )$$

where N is the number of devices of equipment 340 in the subplant, tₛ is the duration of a time step, bⱼ is a binary on/off decision (e.g., 0=off, 1=on), and uⱼ is the energy used by device j as a function of the setpoint θ_{LL}. Each device may have continuous variables which can be changed to determine the lowest possible energy consumption for the overall input conditions.

Low level optimizer 332 may minimize the low level cost function J_{LL} subject to inequality constraints based on the capacities of equipment 340 and equality constraints based on energy and mass balances. In some embodiments, the optimal low level decisions θ*_{LL} are constrained by switching constraints defining a short horizon for maintaining a device in an on or off state after a binary on/off switch. The switching constraints may prevent devices from being rapidly cycled on and off. In some embodiments, low level optimizer 332 performs the equipment level optimization without considering system dynamics. The optimization process may be slow enough to safely assume that the equipment control has reached its steady-state. Thus, low level optimizer 332 may determine the optimal low level decisions θ*_{LL} at an instance of time rather than over a long horizon.

In some embodiments, the optimal low level decisions θ*_{LL} are constrained by an equipment staging coordinator 344 that prevents two or more of subplants 202-212 from reacting to a change in the subplant load too quickly after a change in another of subplants 202-212 has occurred. For example, equipment staging coordinator 344 is shown receiving equipment status information from BAS 308. Equipment staging coordinator 344 may use the equipment status information to determine when the equipment 340 within a given subplant has been staged (e.g., turned on/off). Equipment staging coordinator 344 may prevent multiple subplants from staging their equipment 340 simultaneously or within a predetermined time period after another subplant has staged its equipment 340. Advantageously, this functionality reduces the peak energy consumption for central plant 200 at any instant in time and results in a lower demand charge.

In some embodiments, equipment staging coordinator 344 causes low level optimizer 332 to halt its efficiency calculations and hold the optimal low level decisions θ*_{LL} for a given subplant at previously-determined values shortly after the equipment 340 for another subplant has been staged (e.g., by providing a freeze signal to low level optimizer 332). Once a threshold time has passed since the equipment 340 for the other subplant has been staged, equipment staging coordinator 344 may allow low level optimizer 332 to resume its efficiency calculations and to determine new values for the optimal low level decisions θ*_{LL} (e.g., by withdrawing the freeze signal).

Low level optimizer 332 may determine optimum operating statuses (e.g., on or off) for a plurality of devices of equipment 340. According to an exemplary embodiment, the on/off combinations may be determined using binary optimization and quadratic compensation. Binary optimization may minimize a cost function representing the power consumption of devices in the applicable subplant. In some embodiments, non-exhaustive (i.e., not all potential combinations of devices are considered) binary optimization is used. Quadratic compensation may be used in considering devices whose power consumption is quadratic (and not linear). Low level optimizer 332 may also determine optimum operating setpoints for equipment using nonlinear optimization. Nonlinear optimization may identify operating setpoints that further minimize the low level cost function J_{LL}. Low level optimizer 332 may provide the on/off decisions and setpoints to building automation system 308 for use in controlling the central plant equipment 340.

In some embodiments, the low level optimization performed by low level optimizer 332 is the same or similar to the low level optimization process described in U.S. patent application Ser. No. 14/634,615 filed Feb. 27, 2015 and titled “Low Level Central Plant Optimization,” the entire disclosure of which is incorporated by reference herein. Low level optimizer 332 may include some or all of the features and/or functionality of the low level optimization module described in U.S. patent application Ser. No. 14/634,615.

### Visualizing Equipment Utilization in a Central Plant

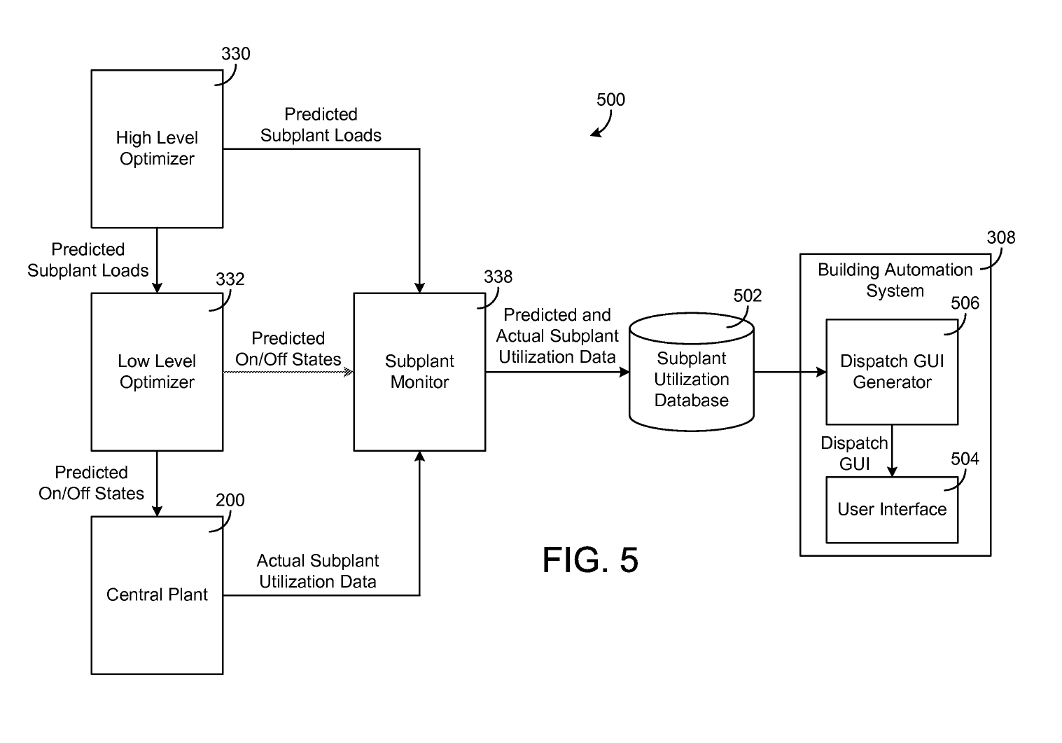

Referring now to FIG. 5, a block diagram illustrating a system 500 for visualizing equipment utilization in a central plant is shown, according to an exemplary embodiment. System 500 is shown to include high level optimizer 330, low level optimizer 332, and central plant 200, which may be the same or similar as described with reference to FIGS. 2-4. For example, high level optimizer 330 may perform an optimization process to generate a set of subplant loads (i.e., predicted subplant loads) for each of subplants 202-212. In some embodiments, the predicted subplant loads include a heating load served by heating subplant 202, a heating load served by heat recovery chiller subplant 204, a cooling load served by heat recovery chiller subplant 204, a cooling load served by chiller subplant 206, a heating load served or stored by hot TES subplant 210 (e.g., a rate at which hot TES subplant 210 is charging or discharging), and/or a cooling load served or stored by cold TES subplant 212 (e.g., a rate at which cold TES subplant 212 is charging or discharging). The heating and cooling loads served by hot TES subplant 210 and cold TES subplant 212, respectively, may be positive if the TES subplant is discharging stored thermal energy or negative if the TES subplant is charging or storing the thermal energy produced by other subplants.

In some embodiments, the predicted subplant loads include a charge state for TES subplants 210-212 defining an amount of thermal energy stored in each of TES subplants 210-212. In some embodiments, the predicted subplant loads include a total cold requested load and a total hot requested load. In some embodiments, the predicted subplant loads include an unmet heating load and/or an unmet cooling load. The unmet heating load may be defined as the amount by which the total requested heating load exceeds the sum of the heating loads produced by subplants 202-212. Similarly, the unmet cooling load may be defined as the amount by which the total requested cooling load exceeds the sum of the cooling loads produced by subplants 202-212. In some embodiments, the predicted subplant loads include a predicted amount of one or more resources (e.g., water, electricity, natural gas, etc.) consumed by subplants 202-212 to generate the predicted subplant loads.

High level optimizer 330 may predict the subplant loads for a plurality of time steps between the current time and a future time horizon. Each of the time steps may have a defined or predetermined duration (e.g., fifteen minutes, one hour, etc.). The predicted subplant loads may be updated with each iteration of the high level optimization process. High level optimizer 330 may provide the predicted subplant loads to low level optimizer 332 and to subplant monitor 338. Subplant monitor 338 may store the predicted subplant loads as predicted subplant utilization data in a subplant utilization database 502.

Low level optimizer 332 may use the predicted subplant loads to generate a set of predicted on/off states for the equipment of subplants 202-212. In some embodiments, low level optimizer performs an optimization process to generate the predicted on/off states. The predicted on/off states may include optimal on/off states for the equipment of each of subplants 202-212 in order for each subplant to meet the predicted subplant load. In some embodiments, the predicted on/off states include an operating status (e.g., on/off) and/or a load setpoint for each of the HVAC devices within subplants 202-212. Low level optimizer 332 may provide the predicted on/off states to central plant 200 and to subplant monitor 338. Subplant monitor 338 may store the predicted on/off states as predicted subplant utilization data in subplant utilization database 502. In various embodiments, subplant utilization database 502 may be a component of central plant controller 302 (e.g., memory 312) or a separate database outside central plant controller 302.

Central plant 200 may use the predicted on/off states to operate the equipment of subplants 202-212. Central plant 200 may monitor the utilization of subplants 202-212 and generate a set of actual subplant utilization data. The actual subplant utilization data may include actual values (rather than predicted values) for each of the subplant loads predicted by high level optimizer 330. For example, the actual subplant utilization data may include an actual heating load served by heating subplant 202, an actual heating load served by heat recovery chiller subplant 204, an actual cooling load served by heat recovery chiller subplant 204, an actual cooling load served by chiller subplant 206, an actual heating load served or stored by hot TES subplant 210 (e.g., a rate at which hot TES subplant 210 is charging or discharging), and/or an actual cooling load served or stored by cold TES subplant 212 (e.g., a rate at which cold TES subplant 212 is charging or discharging). The actual heating and cooling loads served by hot TES subplant 210 and cold TES subplant 212, respectively, may be positive if the TES subplant is discharging stored thermal energy or negative if the TES subplant is charging or storing the thermal energy produced by other subplants.

In some embodiments, the actual subplant utilization data include a charge state for TES subplants 210-212 defining an actual amount of thermal energy stored in each of TES subplants 210-212. In some embodiments, the actual subplant utilization data include a total cold requested load and a total hot requested load. In some embodiments, the actual subplant utilization data include an actual unmet heating load and/or unmet cooling load. In some embodiments, the actual subplant utilization data include an actual amount of one or more resources (e.g., water, electricity, natural gas, etc.) consumed by subplants 202-212 to generate the actual subplant loads.

Central plant 200 may report the actual subplant utilization data to subplant monitor 338. In some embodiments, central plant 200 reports the actual subplant utilization data at regular intervals (e.g., once every fifteen minutes, once per hour, etc.) Subplant monitor 338 may store the actual subplant utilization data in subplant utilization database 502. In some embodiments, subplant monitor 338 overwrites or replaces the predicted subplant utilization data for a given time step with the actual subplant utilization data for the time step once the actual subplant utilization data for the time step is available (e.g., once the current time advances to the time step). Similarly, subplant monitor 338 may overwrite or replace the predicted subplant data for a given time step with an updated prediction for the time step each time a new set of predicted subplant utilization data is generated by high level optimizer 330. In other embodiments, subplant monitor 338 supplements the existing predicted subplant utilization data with the updated predicted subplant utilization data and/or the actual subplant utilization data without replacing or overwriting the exiting subplant utilization data. For example, the existing subplant utilization data may be stored as a first version of the subplant utilization data and the updated subplant utilization data may be stored as a second version of the subplant utilization data.

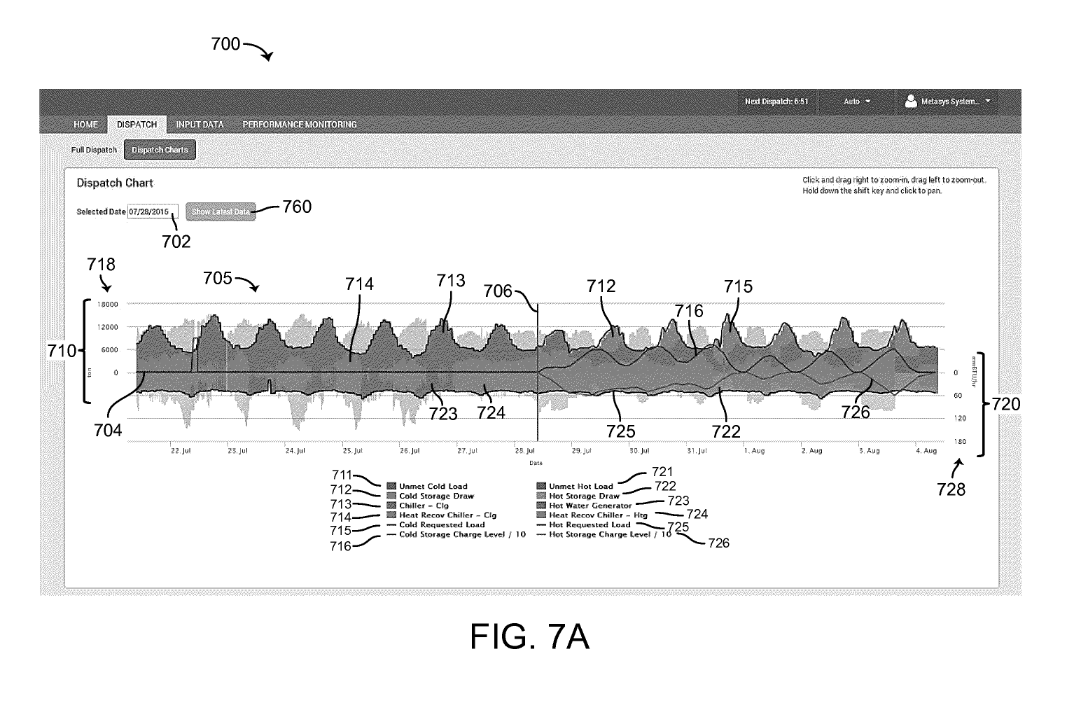

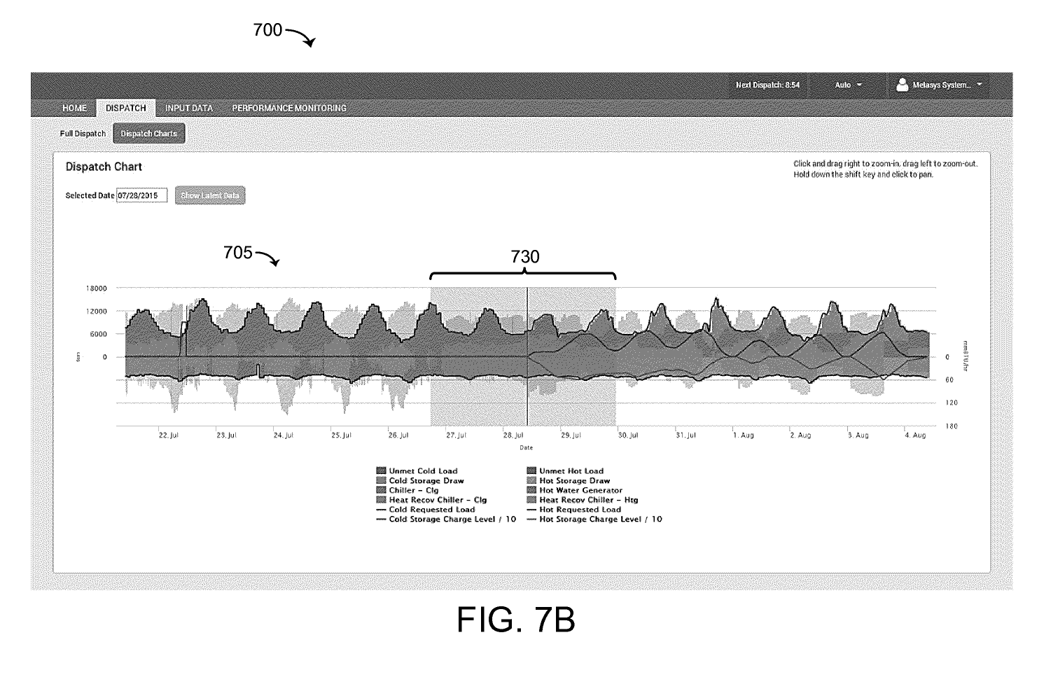

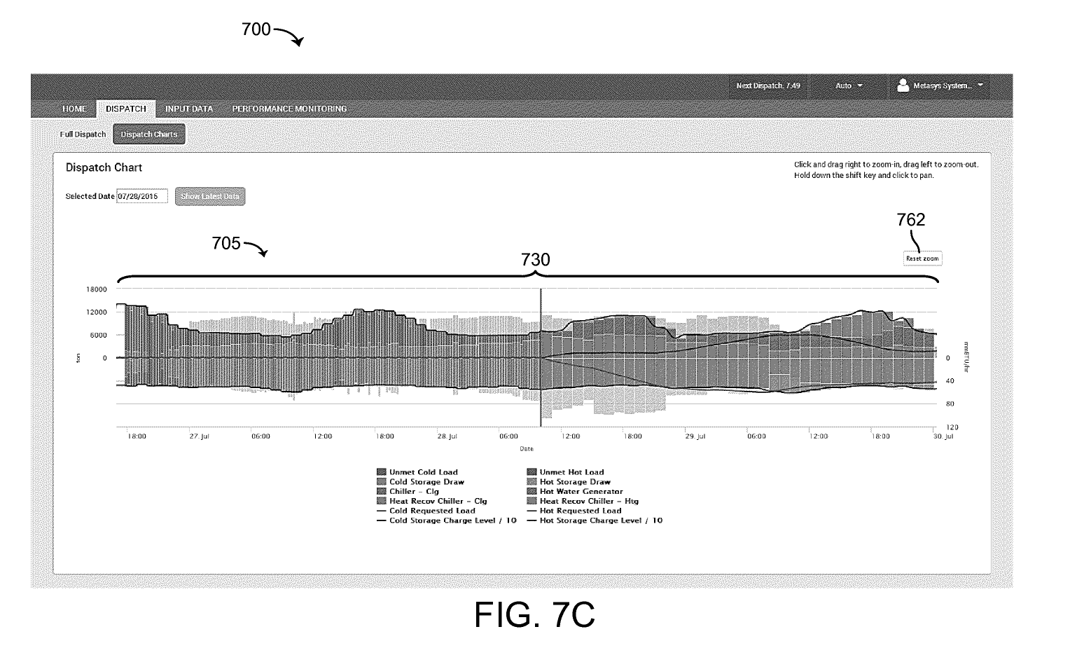

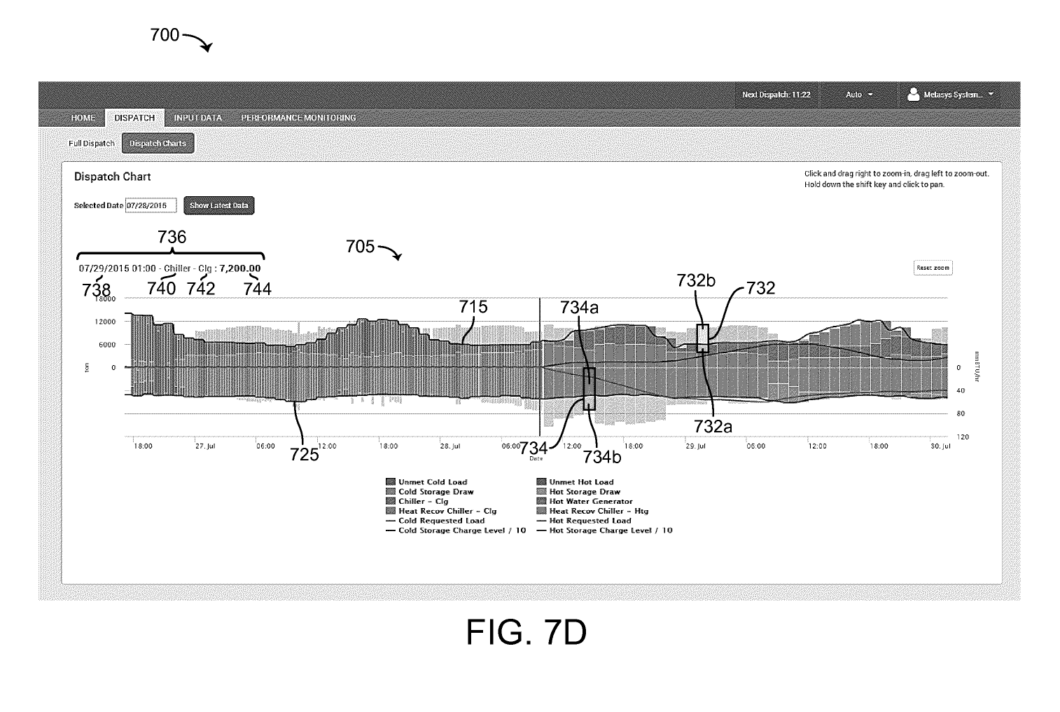

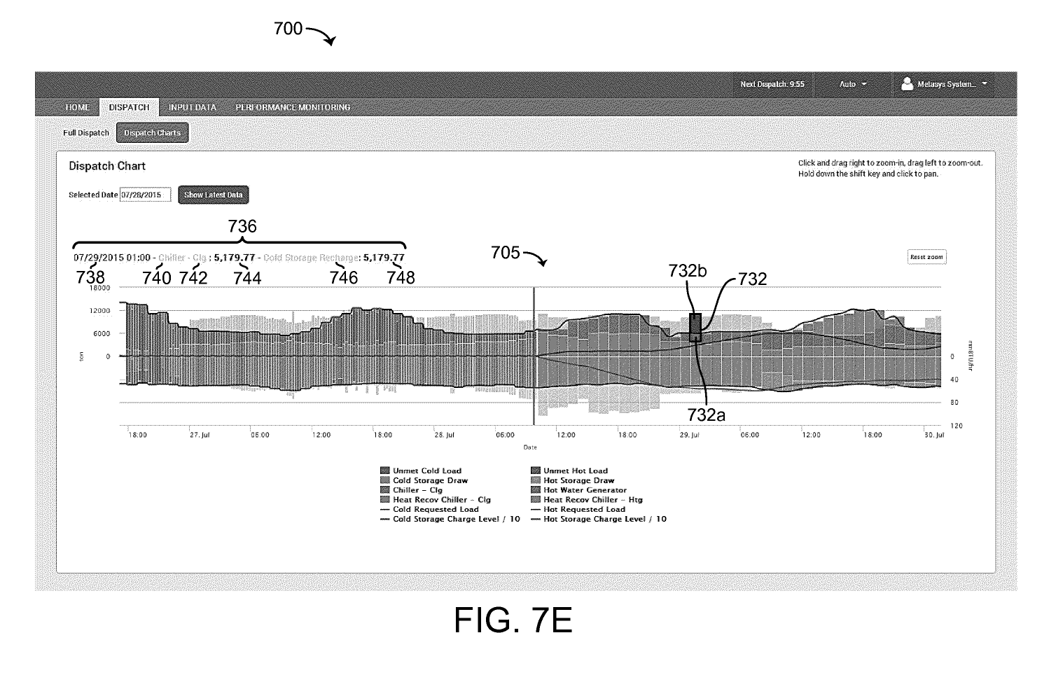

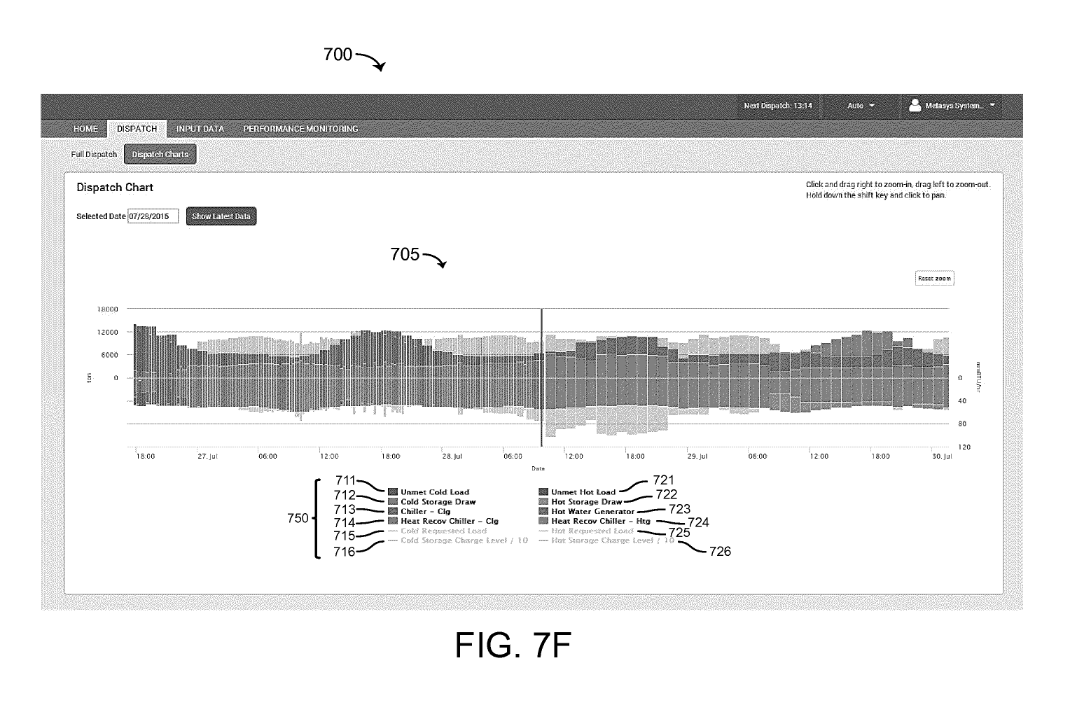

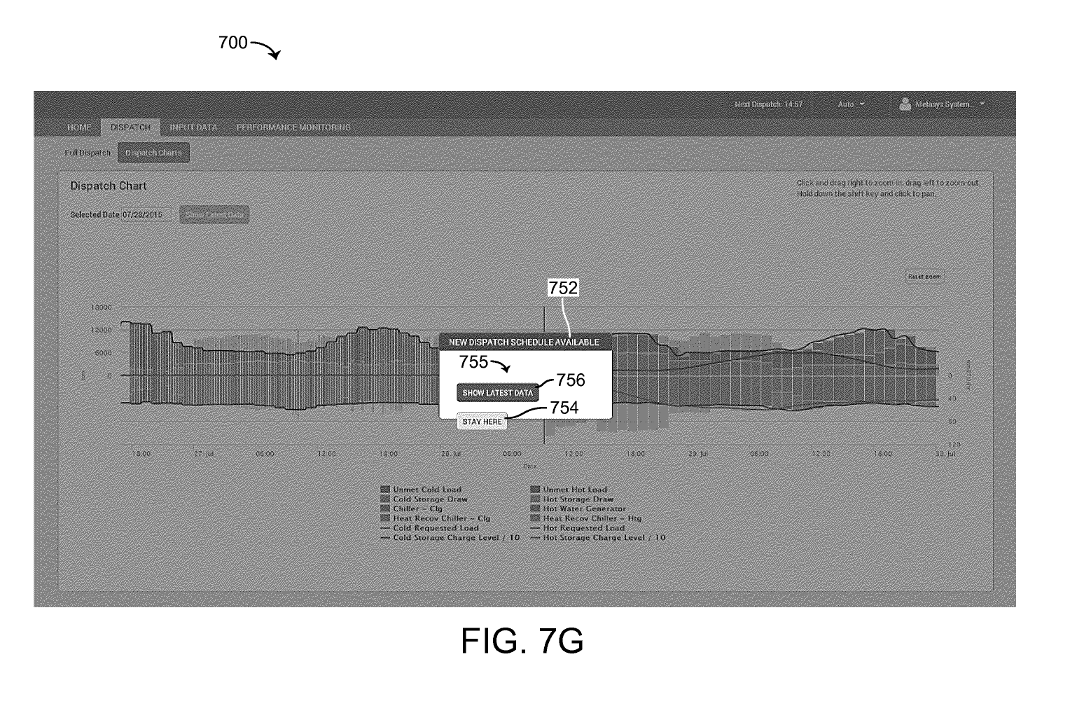

Still referring to FIG. 5, system 500 is shown to include a dispatch GUI generator 506. Dispatch GUI generator 506 may access the data stored in subplant utilization database 502 and use the stored data to generate a dispatch GUI. The dispatch GUI may be a graph or chart that illustrates the actual subplant utilization data (e.g., past and current subplant loads) and the predicted subplant utilization data (e.g., future subplant loads) in a graphical format. Exemplary dispatch GUIs which may be generated by dispatch GUI generator 506 are described in greater detail with reference to FIGS. 6A-7G. Dispatch GUI generator 506 may provide the dispatch GUI to a user interface 504 of a client device (e.g., a computer terminal, a workstation, a laptop, a tablet, a smartphone, etc.).

In some embodiments, dispatch GUI generator 506 and user interface 504 are components of BAS 308 (as shown in FIG. 5) or components of central plant controller 302 (e.g., monitoring and reporting applications 336). Dispatch GUI generator 506 may generate the dispatch GUI and provide the dispatch GUI to user interface 504 via a communications network. In other embodiments, dispatch GUI generator 506 is a component of the client device. For example, dispatch GUI generator 506 may be a web browser or a specialized application running on the client device. In some embodiments, the dispatch GUI is rendered using specialized viewing software (e.g., a central plant monitoring application) installed on the client device. In other embodiments, the dispatch GUI is provided via a web interface which allows the dispatch GUI to be rendered and viewed using a web browser without requiring any specialized applications or software to be installed on the client device. Advantageously, the actual and predicted subplant utilization data presented via the dispatch GUI may allow a user to make informed decisions regarding the operation of central plant 200 (e.g., control decisions, diagnostic decisions, configuration decisions, subplant utilization decisions, etc.).

In some embodiments, user interface 504 is a comprehensive monitoring and control interface that allows a user to monitor the operation of central plant 200 via the dispatch GUI (e.g., monitoring the actual and predicted subplant loads, equipment states, etc.) and to provide control inputs to the equipment of central plant 200 and/or BAS 308. In addition to displaying the dispatch GUI generated by dispatch GUI generator 506, user interface 504 may be configured to receive input from a user via the dispatch GUI. For example, the dispatch GUI presented via user interface 504 may include interface options that allow a user to change the load setpoints for subplants 202-212, change the on/off states or operating setpoints for equipment 340, activate or deactivate entire subplants or individual devices of equipment 340, adjust the configuration of BAS 308 or central plant 200, or otherwise monitor and control the operation of central plant 200 and/or equipment 340. BAS 308 may control central plant 200 and/or equipment 340 (e.g., via actuators, power relays, etc.) in accordance with the user input received via user interface 504. In some embodiments, the user input received via user interface 504 overrides automated control decisions made by central plant controller 302.

### Dispatch GUIs

Referring now to FIGS. 6A-6D, a dispatch GUI 600 which may be generated by dispatch GUI generator 506 is shown, according to an exemplary embodiment. Dispatch GUI 600 presents the predicted and actual subplant utilization data for central plant 200 in a graphical format. Dispatch GUI 600 is shown to include four separate graphs 610, 630, 650, and 670, each of which presents a different view of the subplant utilization data. In some embodiments, two or more of graphs 610, 630, 650, and 670 are displayed concurrently. For example, each of graphs 610, 630, 650, and 670 may be displayed on the same screen or page of dispatch GUI 600. In other embodiments, each of graphs 610, 630, 650, and 670 may be displayed separately (e.g., on different screens or pages of dispatch GUI 600). For embodiments in which graphs 610, 630, 650, and 670 are displayed concurrently, two or more of graphs 610, 630, 650, and 670 may share a common axis. For example, each of graphs 610, 630, 650, and 670 may share a common time axis 604.

In some embodiments, graphs 610, 630, 650, and 670 are temporally aligned. For example, dispatch GUI 600 is shown to include a current time line 602. Current time line 602 indicates the current time and is shown as a straight line that extends through each of graphs 610, 630, 650, and 670. All of the data shown to the left of current time line 602 represents past (i.e., actual) subplant utilization data, whereas all of the data shown to the right of current time line 602 represents future (i.e., predicted) subplant utilization data. The data aligned with current time line 602 represents the current subplant utilization data.

Referring particularly to FIG. 6A, a subplant loads graph 610 is shown, according to an exemplary embodiment. Subplant loads graph 610 illustrates the actual and predicted subplant loads for each of subplants 202-212 at each of the time steps represented in dispatch GUI 600. Advantageously, subplant loads graph 610 shows the heating and/or cooling loads produced by each of subplants 202-212 during each time step as separate bars to illustrate the contribution of each of subplants 202-212 to the requested heating and cooling loads. The bars may stack on top of each other to indicate whether the total heating or cooling load production meets, exceeds, or fails to meet the requested heating and cooling loads.

Subplant loads graph 610 is shown to include a top half 612 which includes cooling-related data (i.e., the data above zero line 601) and a bottom half 614 which includes heating-related data (i.e., the data below zero line 601). Both halves 612 and 614 of subplant load graph 610 represent positive deviations from zero. For example, the scales that accompany axes 603 and 605 become increasingly positive as the distance from zero line 601 increases for both top half 612 and bottom half 614. In FIG. 6, the magnitude of a cooling load is shown as an upward deviation from zero line 601, whereas the magnitude of a heating load is shown as a downward deviation from zero line 601. Legend 611 identifies the different types of data represented in subplant loads graph 610.

The bars above zero line 601 represent amounts and/or rates of cooling provided by the subplants of central plant 200 equipped to handle cooling. For example, bars 619 indicate the cooling provided by chiller subplant 206, bars 620 indicate the cooling provided by heat recovery chiller subplant 204, and bars 618 represent the cooling provided by discharging cold TES subplant 212. If any unmet cooling loads are present, bars 617 may indicate the amount of the unmet cooling load. Requested cooling line 616 indicates the requested cooling load. Axis 603 provides the scale and/or units for bars 617-620 and for requested cooling line 616. In some embodiments the cooling loads measured by axis 603 are presented as cooling rates in units of tons.

Bars 618-620 positioned between zero line 601 and requested cooling line 616 indicate cooling production that contributes to the requested cooling load. Bars 618-620 positioned above requested cooling line 616 indicate cooling production in excess of the requested cooling load. Excess cooling production may be used to charge cold TES subplant 212. The amount of excess cooling production used to recharge cold TES subplant 212 may be indicated by a label 615 above each of the excess cooling bars.

In some embodiments, top half 612 includes a cold storage charge level line 621 that indicates the charge level of cold TES subplant 212. The charge level of cold TES subplant 212 may increase when excess cooling load is produced and used to charge cold TES subplant 212 (indicated by bars 619 and/or 620 above requested cooling line 616). The charge level of cold TES subplant 212 may decrease when cold TES subplant 212 is discharged to meet the requested cooling load. Discharging stored thermal energy from cold TES subplant 212 is indicated by bars 618. Axis 605 provides the scale and/or units for cold storage charge level line 621. In some embodiments the charge level measured by axis 605 is presented as a cooling amount in units of ton-hours.

The bars below zero line 601 represent amounts and/or rates of heating provided by the subplants of central plant 200 equipped to handle heating. For example, bars 624 indicate the heating provided by heater subplant 202, bars 623 indicate the heating provided by heat recovery chiller subplant 204, and bars 625 represent the heating provided by discharging hot TES subplant 210. If any unmet heating loads are present, bars 626 may indicate the amount of the unmet heating load. Requested heating line 627 indicates the requested heating load.

Axis 603 provides the scale and/or units for bars 623-626 and for requested heating line 627. In some embodiments the heating loads measured by axis 603 are presented as heating rates in units of mmBTU/hr. In some embodiments, the portion of axis 603 below zero line 601 may have different units than the portion of axis 603 above zero line 601. For example, the portion of axis 603 above zero line 601 may measure the cooling loads in units of tons, whereas the portion of axis 603 below zero line 601 may measure the heating loads in units of mmBTU/hr.

Bars 623-624 positioned between zero line 601 and requested heating line 627 indicate heating production that contributes to the requested heating load. Bars 623-624 positioned below requested heating line 627 indicate heating production in excess of the requested heating load. Excess heating production may be used to charge hot TES subplant 210. The amount of excess heating production used to recharge hot TES subplant 210 may be indicated by a label 628 below each of the excess heating bars.

In some embodiments, bottom half 614 includes a hot storage charge level line 622 that indicates the charge level of hot TES subplant 210. The charge level of hot TES subplant 210 may increase when excess heating load is produced and used to charge hot TES subplant 210 (indicated by bars 623 and/or 624 below requested heating line 627). The charge level of hot TES subplant 210 may decrease when hot TES subplant 210 is discharged to meet the requested heating load. Discharging stored thermal energy from hot TES subplant 210 is indicated by bars 625.

Axis 605 provides the scale and/or units for hot storage charge level line 622. In some embodiments the charge level measured by axis 605 is presented as a heating amount in units of mmBTU. In some embodiments, the portion of axis 605 below zero line 601 may have different units than the portion of axis 605 above zero line 601. For example, the portion of axis 605 above zero line 601 may measure the cold TES charge level in units of ton-hours, whereas the portion of axis 605 below zero line 601 may measure the hot TES charge level in units of mmBTU.

Referring particularly to FIG. 6B, a TES charge level graph 630 is shown, according to an exemplary embodiment. TES charge level graph 630 illustrates the actual and predicted charge levels of hot TES subplant 210 and cold TES subplant 212 at each of the time steps represented in dispatch GUI 600. In some embodiments, TES charge level graph 630 provides the same data shown by cold TES charge level line 621 and hot TES charge level line 622 in graph 610, but in bar from rather than line form.

TES charge level graph 630 is shown to include a top half 632 which includes cooling-related data (i.e., the data above zero line 639) and a bottom half 614 which includes heating-related data (i.e., the data below zero line 639). Legend 631 identifies the different types of data represented in TES charge level graph 630. For example, TES charge level graph 630 is shown to include cold storage charge level bars 636 which represent the charge level of cold TES subplant 212. If any unmet cooling loads 635 are present, the unmet cooling loads may be shown as bars in top half 632. TES charge level graph 630 is shown to further include hot storage charge level bars 637 which represent the charge level of hot TES subplant 210. If any unmet heating loads 638 are present, the unmet heating loads may be shown as bars in bottom half 634.

Axis 606 provides the scale and/or units for cold storage charge level bars 636 and hot storage charge level bars 637. In some embodiments the charge level measured by axis 606 is presented as a cooling amount in units of ton-hours or a heating amount in units of mmBTU. In some embodiments, the portion of axis 606 below zero line 639 may have different units than the portion of axis 606 above zero line 639. For example, the portion of axis 606 above zero line 639 may measure the cold TES charge level in units of ton-hours, whereas the portion of axis 606 below zero line 639 may measure the hot TES charge level in units of mmBTU.

Referring particularly to FIG. 6C, a resource consumption graph 650 is shown, according to an exemplary embodiment. Resource consumption graph 650 may illustrate the amounts, rates, and/or costs of resources consumed by subplants 202-212 to produce the heating and cooling loads shown in graph 610. Legend 651 identifies the different types of data represented in resource consumption graph 650. For example, resource consumption graph 650 is shown to include a total electricity consumption line 652 which measures the total electricity consumption of central plant 200 and the building or campus served by central plant 200. Resource consumption graph 650 is shown to include an electrical demand constraint line 654 which indicates the maximum desired or allowable electricity consumption and an electrical demand target line 656 which indicates the target electricity consumption.

Resource consumption graph 650 is shown to include bars 660 which represent the total electricity consumption of central plant 200. The electricity consumption of central plant 200 may include the electricity used to power the devices of subplants 202-212 that produce the heating and cooling loads. For example, bars 660 may represent the electricity consumption of chillers 232, heat recovery heat exchangers 226, heaters 220, and any pumps used to circulate the heated or chilled fluids within subplants 202-212.

Resource consumption graph 650 is shown to include bars 658 which represent other electricity consumption. The other electricity consumption may include electricity consumed by devices of central plant 200 that do not directly contribute to the heating or cooling loads. For example, bars 658 may represent the electricity consumption of lighting used to light central plant 200, controllers or other electronics within central plant 200, or other devices of central plant 200 that do not contribute to the heating or cooling loads served by central plant 200. In some embodiments, bars 658 also represent the electricity consumption of the building or campus served by central plant 200. Bars 658 and 660 together may represent the total electricity consumption represented by total electricity consumption line 652.

Bars 658-660 below total electricity consumption line 652 indicate electricity consumption that contributes to the total electricity consumption. Bars 658-660 above total electricity consumption line 652 indicate electricity production via a photovoltaic energy source (e.g., solar panels). The amount of photovoltaic electricity production may be indicated by a label 664 above each of the bars above electricity consumption line 652. Photovoltaic electricity production may be used to reduce the total electricity purchased from a utility provider (indicated by consumption line 652) by substituting photovoltaic energy for purchased electricity.

Axis 607 provides the scale and/or units for total electricity consumption line 652, electrical demand constraint line 654, electrical demand target line 656, and bars 658-660. In some embodiments the electricity consumption measured by axis 607 is presented as a power measured in units of kW. Axis 608 provides the scale and/or units for the electric unit costs 662 (e.g., the per unit monetary cost of electricity consumption). In some embodiments the electric unit costs 662 are measured in units of dollars or dollars per unit energy.

Referring particularly to FIG. 6D, another resource consumption graph 670 is shown, according to an exemplary embodiment. Resource consumption graph 670 may illustrate the amounts, rates, and/or costs of resources consumed by subplants 202-212 to produce the heating and cooling loads shown in graph 610. Legend 671 identifies the different types of data represented in resource consumption graph 670. For example, resource consumption graph 650 is shown to include gas usage bars 672 which represent the natural gas consumption of central plant 200. The natural gas consumption of central plant 200 may include the natural gas used to power the devices of subplants 202-212 that produce the heating and cooling loads. For example, bars 672 may represent the natural gas burned by heaters 220 to generate the heated fluid within heater subplant 202.

Axis 609 provides the scale and/or units for total gas usage bars 672. In some embodiments the natural gas usage measured by axis 609 is presented as a power measured in units of kW. Axis 613 provides the scale and/or units for the natural gas unit costs 674 (e.g., the monetary cost per unit of natural gas consumption). In some embodiments the natural gas unit costs 674 are measured in units of dollars or dollars per unit energy.

In some embodiments, dispatch GUI 600 is interactive and can be manipulated (e.g., by a user) to define a customized view of the subplant utilization data. For example, the range of times/dates represented in dispatch GUI 600 can be adjusted (e.g., by a user) to view any subset of the subplant utilization data stored in subplant utilization database 502. In some embodiments, dispatch GUI 600 provides a user interface option to hide the numerical values within each of the bars. When the numerical values are hidden, selecting or hovering over one of the bars may cause dispatch GUI 600 to display the numerical value associated with the bar. In some embodiments, dispatch GUI 600 provides user interface options to hide or show sets of data. For example, clicking on a data label in any of legends 611, 631, 651, or 671 may cause the corresponding bars, lines, or other data to be removed from graphs 610, 630, 650 and/or 670. Clicking on the data label again may cause the corresponding bars, lines, or other data to reappear.

Referring now to FIGS. 7A-7G, another dispatch GUI 700 which may be generated by dispatch GUI generator 506 is shown, according to an exemplary embodiment. Dispatch GUI 700 presents the predicted and actual subplant utilization data for central plant 200 in a graphical format. Dispatch GUI 700 may include some or all of the features of dispatch GUI 600, as described with reference to FIGS. 6A-6D. For example, dispatch GUI 700 is shown to include a stacked bar graph 705 which represents the actual and predicted subplant loads for subplants 202-212.

Stacked bar graph 705 is shown to include a cooling data portion 710 which represents the cooling-related subplant utilization data and a heating data 720 which represents the heating-related subplant utilization data. Cooling data portion 710 may include bars which represent the unmet cold load 711, the cold storage draw 712, the chiller subplant load 713, and the heat recovery chiller subplant load 714. Each of bars 712-714 represents the cooling output of one of subplants 202-212 for a particular time step. Cooling data portion 710 may also include lines which represent the cold requested load 715 and the cold storage charge level 716. Similarly, heating data portion 720 may include bars which represent the unmet heating load 721, the hot storage draw 722, the heater subplant load 723, and the heat recovery chiller subplant load 714. Each of bars 722-714 represents the heating output of one of subplants 202-212 for a particular time step. Heating data portion 720 may also include lines which represent the hot requested load 725 and the hot storage charge level 726.

In some embodiments, cooling data portion 710 and heating data portion 720 have separate scales. For example, cooling data portion 710 is shown to include a cooling scale 718 on the left side of stacked bar graph 705 and above zero line 704. Cooling scale 718 may measure cooling loads in units of tons. Heating data portion 720 is shown to include a heating scale 728 on the right side of stacked bar graph 705 and below zero line 704. Heating scale 728 may measure heating loads in units of mmBTU/hr. Both cooling data portion 710 and heating data portion 720 represent positive loads. The magnitude of a cooling load may be represented by the size of bars 712-714 and/or a distance above zero line 704. Similarly, the magnitude of a heating load may be represented by the size of bars 722-714 and/or a distance below zero line 704.

In some embodiments, dispatch GUI 700 includes a predetermined amount of past subplant utilization data (e.g., one hour, one day, seven days, one month, one year, etc.) and a predetermined amount of predicted subplant utilization data (e.g., one hour, one day, seven days, one month, one year, etc.). For example, FIG. 7A is shown to include seven days of past (i.e., actual) subplant utilization data to the left of current time line 706 and seven days of future (i.e., predicted) subplant utilization data to the right of current time line 706. In some embodiments, the range of times/dates represented in dispatch GUI 700 may include any range of times/dates for which subplant utilization data is available in subplant utilization database 502. For example, dispatch GUI 700 may provide a window through which any or all of the subplant utilization data in subplant utilization database 502 can be viewed. For example, dispatch GUI 700 is shown to include date selector 702 (e.g., a text box). Selecting a particular date via date selector 702 may cause dispatch GUI 700 to center at the selected date (e.g., with the selected date shown at the midpoint of dispatch GUI 700. In other embodiments, date selector 702 may include multiple text boxes, a slider, or other time/date selectors that can be used to define a range of times represented in dispatch GUI 700.

In some embodiments, the window of subplant utilization data shown in dispatch GUI 700 can be adjusted (e.g., by a user) to zoom out and view a larger window of subplant utilization data or to zoom in and view a subset of the subplant utilization data more particularly. For example, a range 730 of the subplant utilization data can be selected, as shown in FIG. 7B. Upon selecting a range of data, dispatch GUI 700 may automatically rescale to show the selected range 730. FIG. 7C shows a view of dispatch GUI 700 that has been rescaled to show a detailed view of a user-defined range 730 of subplant utilization data. When a user-defined range of data is shown, dispatch GUI 700 may provide a user interface option (e.g., “reset zoom” button 762) to reset the view to the default view shown in FIG. 7A.

In some embodiments, the past subplant utilization data is presented in intervals of fifteen minutes, whereas the future subplant utilization data is presented in intervals of one hour. The greater granularity for the past (i.e., actual) subplant utilization data may provide a greater level of detail regarding the actual operation of central plant 200. The lesser granularity for the future (i.e., predicted) subplant utilization data may allow a user or operator to view the upcoming dispatch schedule without focusing on narrow intervals since the future subplant utilization data is subject to change with each iteration of the high level optimization process.

Referring now to FIG. 7D, dispatch GUI 700 may indicate an amount of a cooling load produced by subplants 202-212 that contributes to the requested cooling load 715. For example, dispatch GUI 700 is shown to include a bar 732 representing the cooling production of chiller subplant 206. A portion of bar 732 (i.e., portion 732a) is between zero line 704 and requested cooling line 715. Portion 732a indicates the amount of the cooling production that contributes to the requested cooling load 715. Another portion of bar 732 (i.e., portion 732b) is above requested cooling line 715. Portion 732b indicates the amount of the cooling production in excess of the requested cooling load 715. In some embodiments, the amount of the cooling production indicated by portion 732b may be used to charge the cold thermal energy storage.

Similarly, dispatch GUI 700 is shown to include a bar 734 representing the heating production of heat recovery chiller subplant 204. A portion of bar 734 (i.e., portion 734a) is between zero line 704 and requested heating line 725. Portion 734a indicates the amount of the heating production that contributes to the requested heating load 725. Another portion of bar 734 (i.e., portion 734b) is below requested heating line 725. Portion 734b indicates the amount of the heating production in excess of the requested heating load 725. In some embodiments, the amount of the heating production indicated by portion 734b may be used to charge the hot thermal energy storage.

In some embodiments, the amounts of the heating or cooling production represented by bars 711-714 and 721-724 may be displayed when a user selects and/or hovers over one of the bars. For example, FIG. 7D shows a load display 736 which may be displayed when a user selects or hovers over bar 732. Load display 736 is shown to include a timestamp 738 indicating a time period or time step associated with the selected bar 732. Load display 736 is also shown to include a subplant indicator 740 indicating a particular subplant that produces the load represented by the selected bar 732, a load type indicator 742 indicating whether the load is a heating load or a cooling load, and a magnitude indicator 744 indicating a size of the load represented by the selected bar 732.

Referring now to FIG. 7E, load display 736 may indicate an amount of the load that contributes to charging the thermal energy storage. For example, when a user selects or hovers over portion 732a (or any other portion of a bar indicating thermal energy production in excess of a requested load), magnitude indicator 744 may indicate an amount of the thermal energy production in excess of the requested load. Portion 732a may be highlighted to indicate that the data values shown in load display 736 apply to portion 732. Load display 736 may also include a recharge indicator 746 indicating that the thermal energy production is being used to charge a particular type of thermal energy storage (e.g. cold storage, hot storage, etc.) and a recharge magnitude indicator 748 indicating an amount of the production that is used to charge the thermal energy storage.

Referring now to FIG. 7F, dispatch GUI 700 may provide user interface options to hide or show sets of data. For example, clicking on any of the data labels 650 may cause the corresponding bars, lines, or other data to be removed from stacked bar graph 705. FIG. 7F shows a view of dispatch GUI 700 in which the lines representing the cold requested load 715, the cold storage charge level 716, the hot requested load 725, and the hot storage charge level 726 have been hidden. The data labels 650 associated with the hidden data may be greyed out or otherwise marked to indicate that the corresponding data is hidden. Clicking on the data labels 650 associated with the hidden data again may cause the corresponding bars, lines, or other data to reappear.

Referring now to FIGS. 7A and 7G, the subplant utilization data may be updated at regular intervals (e.g., once every fifteen minutes) and/or each time the high level optimization process is performed. In some embodiments, dispatch GUI 700 includes a countdown timer 708 (shown in FIG. 7A) or other user interface feature indicating when the next scheduled update will occur. The subplant utilization data can also be updated on demand (e.g., by selecting an “update now” button presented via dispatch GUI 700). In some embodiments, selecting the “update now” button causes the high level optimizer 330 to perform an iteration of the high level optimization process and to store the updated subplant loads in subplant utilization database 502. Updating the subplant utilization data may include retrieving the most current version of the subplant utilization data from subplant utilization database 502 and regenerating dispatch GUI 700 based on the updated subplant utilization data.

In some instances, an update to the subplant utilization data stored in subplant utilization database 502 may occur while a user is viewing dispatch GUI 700. When a new version of the subplant utilization data is stored in subplant utilization database 502 while dispatch GUI 700 is being viewed, dispatch GUI 700 may display a message 752 indicating that a new version of data is available. The message 752 may include a prompt 755 for the user to select whether to continue viewing the existing version of subplant utilization data (i.e., the version of subplant utilization data currently being displayed) or to switch to the most recent version of subplant utilization data.

If the user selects to continue viewing the existing version of subplant utilization data (e.g., by selecting “stay here” button 754), prompt 755 may disappear and the user may continue viewing the set of subplant utilization data that was being viewed before the prompt was displayed. When an outdated version of subplant utilization data (e.g., any version other than the most recent version) is displayed, dispatch GUI 700 may show or make selectable a “show latest data” button 760. Selecting “show latest data” button 760 may cause dispatch GUI 700 to be regenerated using the most recent version of the subplant utilization data.

If the user selects to switch to the most recent set of subplant utilization data (e.g., by selecting “show latest data” button 756), prompt 755 may disappear and dispatch GUI 700 may be regenerated using the most recent subplant utilization data. In some embodiments, if the user does not make a selection within a predetermined time period after the prompt is displayed, dispatch GUI 700 may automatically switch to the most recent set of subplant utilization data. Advantageously, this feature may ensure that dispatch GUI 700 displays the most recent subplant utilization data when a user returns to the user interface after being away from the user interface for a period of time.

### Process for Visualizing Equipment Utilization Data

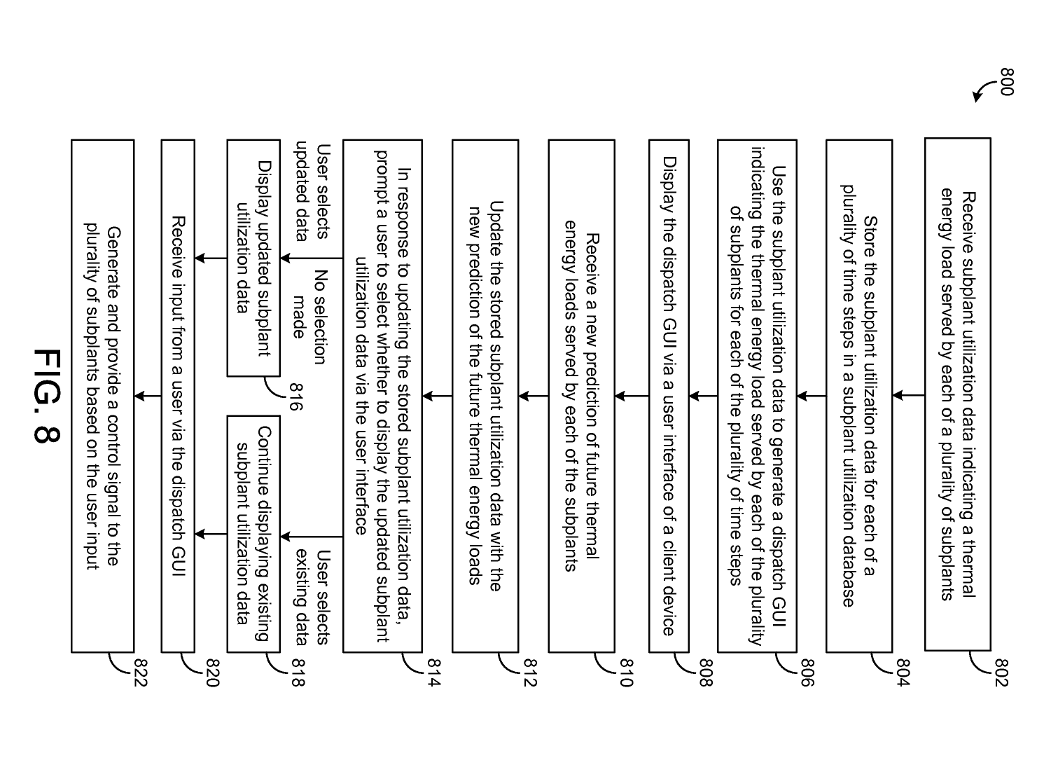

Referring now to FIG. 8, a flowchart of a process 800 for visualizing equipment utilization in a central plant is shown, according to an exemplary embodiment. In some embodiments, process 800 is performed by one or more components of system 500, as described with reference to FIG. 5. Process 800 may be used to generate dispatch GUI 600 and display dispatch GUI 600 via a user interface of a client device.

Process 800 is shown to include receiving subplant utilization data indicating a thermal energy load served by each of a plurality of subplants (step 802). The thermal energy load may include at least one of a heating load and a cooling load. In some embodiments, the subplant utilization data includes actual subplant utilization data and predicted subplant utilization data. The actual subplant utilization data may include an indication of an actual past or current thermal energy load served by each of the plurality of subplants. In some embodiments, the actual subplant utilization data is obtained by monitoring the operation of the plurality of subplants in the central plant. The predicted subplant utilization data may include a prediction of future thermal energy loads served by each of the plurality of subplants. In some embodiments, the predicted subplant utilization data is generated by a central plant optimizer (e.g., central plant optimizer 328) configured to predict the loads on each of the plurality of subplants for a plurality of time steps within a prediction window.

In some embodiments, the subplant utilization data include a heating load served by heating subplant 202, a heating load served by heat recovery chiller subplant 204, a cooling load served by heat recovery chiller subplant 204, a cooling load served by chiller subplant 206, a heating load served or stored by hot TES subplant 210 (e.g., a rate at which hot TES subplant 210 is charging or discharging), and/or a cooling load served or stored by cold TES subplant 212 (e.g., a rate at which cold TES subplant 212 is charging or discharging). The heating and cooling loads served by hot TES subplant 210 and cold TES subplant 212, respectively, may be positive if the TES subplant is discharging stored thermal energy or negative if the TES subplant is charging or storing the thermal energy produced by other subplants.

In some embodiments, the subplant utilization data include a charge state for TES subplants 210-212 defining an amount of thermal energy stored in each of TES subplants 210-212. In some embodiments, the subplant utilization data include a total cold requested load and a total hot requested load. In some embodiments, the subplant utilization data include an unmet heating load and/or an unmet cooling load. The unmet heating load may be defined as the amount by which the total requested heating load exceeds the sum of the heating loads produced by subplants 202-212. Similarly, the unmet cooling load may be defined as the amount by which the total requested cooling load exceeds the sum of the cooling loads produced by subplants 202-212. In some embodiments, the subplant utilization data include an amount of one or more resources (e.g., water, electricity, natural gas, etc.) consumed by subplants 202-212 to generate the subplant loads.

Still referring to FIG. 8, process 800 is shown to include storing the subplant utilization data for each of a plurality of time steps in a subplant utilization database (step 804). The plurality of time steps may include past time steps and future time steps. Step 804 may include storing the actual subplant utilization data for the past and current time steps and storing the predicted subplant utilization data for the future time steps.

Process 800 is shown to include using the subplant utilization data to generate a dispatch GUI (step 806). The dispatch GUI may indicate the thermal energy load served by each of the plurality of subplants for each of the plurality of time steps. In some embodiments, the dispatch GUI includes some or all of the features of dispatch GUI 600, as described with reference to FIGS. 6A-6D. For example, the dispatch GUI may include a set of stacked bars for each of the time steps. Each of the stacked bars may represent the thermal energy load served by one of the subplants during a corresponding time step. The size or height of each of the stacked bars may be based on a magnitude of the represented thermal energy load. In some embodiments, each of the stacked bars includes numerical text indicating the magnitude of the thermal energy load represented by the bar. The total size of a set of stacked bars may represent the total thermal energy load (e.g., a heating load or a cooling load) produced by the plurality of subplants during the corresponding time step. The thermal energy load may be used to satisfy the thermal energy demand of a building and/or stored in thermal energy storage for later use.

In some embodiments, the dispatch GUI includes a requested load line representing a total thermal energy load requested to be served by the plurality of subplants during each of the time steps. In some embodiments, the dispatch GUI includes an excess load value indicating an amount by which a combined magnitude of the thermal energy loads represented by the stacked bars for a time step exceeds the requested thermal energy load for the time step. In some embodiments, the dispatch GUI includes a thermal energy storage line representing a charge state for a thermal energy storage subplant (e.g., hot TES subplant 210, cold TES subplant 212) during each of the time steps. The charge state of the thermal energy storage may increase when excess thermal energy load is produced and stored in the thermal energy storage (i.e., the thermal energy storage is charged). The charge state of the thermal energy storage may decrease when the stored thermal energy is used to serve the requested thermal energy load (i.e., the thermal energy storage is discharged).

In some embodiments, the dispatch GUI includes a zero line, a first set of stacked bars extending in a first direction from the zero line (e.g., above the zero line), and a second set of stacked bars extending in a second direction from the zero line opposite the first direction (e.g., below the zero line). Each of the first set of stacked bars may represent a cooling load served by a corresponding subplant configured to serve cooling loads. Each of the second set of stacked bars may represent a heating load served by a corresponding subplant configured to serve heating loads. In this way, all of the cooling loads may be represented by deviations from the zero line in the first direction and all of the heating loads may be represented by deviations from the zero line in the second direction. In some embodiments, the dispatch GUI includes a separate scale for each of the first and second directions (e.g., a cooling scale above the zero line and a heating scale below the zero line). In some embodiments, the separate scales are provided on opposite sides of the dispatch GUI. For example, the cooling scale may be provided along a left side of the dispatch GUI above the zero line, whereas the heating scale may be provided along a right side of the dispatch GUI below the zero line.

In some embodiments, the dispatch GUI includes a predetermined amount of past subplant utilization data (e.g., one hour, one day, seven days, one month, one year, etc.) and a predetermined amount of predicted subplant utilization data (e.g., one hour, one day, seven days, one month, one year, etc.). In other embodiments, the range of times represented in the dispatch GUI may include any range of times for which subplant utilization data is available in the subplant utilization database. For example, the dispatch GUI may provide a window through which any or all of the subplant utilization data in the subplant utilization database can be viewed. The window can be adjusted (e.g., by a user) to zoom out and view a larger window of subplant utilization data or to zoom in and view a subset of the subplant utilization data more particularly. In some embodiments, the dispatch GUI includes a time selector (e.g., a text box, a slider, etc.) that can be used to define a range of times represented in the dispatch GUI. In some embodiments, the dispatch GUI includes a date selector which centers the dispatch GUI on a selected date.

In some embodiments, the dispatch GUI is interactive and can be manipulated (e.g., by a user) to define a customized view of the subplant utilization data. For example, the dispatch GUI may provide a user interface option to hide the numerical values within each of the bars. When the numerical values are hidden, selecting or hovering over one of the bars may cause the dispatch GUI to display the numerical value associated with the bar. In some embodiments, the dispatch GUI provides user interface options to hide or show sets of data. For example, clicking on a data label (e.g., in a legend portion of the dispatch GUI) may cause the corresponding bars, lines, or other data to be removed from the dispatch GUI. Clicking on the data label again may cause the corresponding bars, lines, or other data to reappear.

In some embodiments, the past subplant utilization data is presented in intervals of fifteen minutes, whereas the future subplant utilization data is presented in intervals of one hour. The greater granularity for the past (i.e., actual) subplant utilization data may provide a greater level of detail regarding the actual operation of the central plant. The lesser granularity for the future (i.e., predicted) subplant utilization data may allow a user or operator to view the upcoming dispatch schedule without focusing on narrow intervals since the future subplant utilization data is subject to change with each iteration of the high level optimization process.

Still referring to FIG. 8, process 800 is shown to include displaying the dispatch GUI via a user interface of a client device (step 808). The client device may include, for example, a computer terminal, a workstation, a laptop, a tablet, a smartphone, or any other device capable of displaying the subplant utilization data in a graphical format. In some embodiments, step 808 includes generating the dispatch GUI at a first computer system (e.g., a BAS controller, a cloud-based computing system, etc.) and providing the dispatch GUI to the client device via a communications network. For example, the dispatch GUI may be generated by a central plant controller (e.g., controller 302) and provided to the client device via a network (e.g., a LAN, the Internet, etc.).

In other embodiments, the dispatch GUI is generated by the client device. For example, the client device may include a web browser or a specialized application configured to access the subplant utilization database and to generate the dispatch GUI using the subplant utilization data stored therein. In some embodiments, the dispatch GUI is rendered using specialized viewing software (e.g., a central plant monitoring application) installed on the client device. In other embodiments, the dispatch GUI is provided via a web interface which allows the dispatch GUI to be rendered and viewed using a web browser without requiring any specialized applications or software to be installed on the client device.

Still referring to FIG. 8, process 800 is shown to include receiving a new prediction of future thermal energy loads served by each of the subplants (step 810) and updating the stored subplant utilization data with the new prediction of the future thermal energy loads (step 812). In some embodiments, steps 810-812 are performed at regular intervals (e.g., once every fifteen minutes) and/or each time the high level optimization process is performed. Steps 810-812 can also be performed on demand (e.g., by selecting an “update now” button presented via the dispatch GUI). In some embodiments, selecting the “update now” button causes the high level optimizer 330 to perform an iteration of the high level optimization process and to store the updated subplant loads in the subplant utilization database.

In some embodiments, the updated subplant utilization data are used to overwrite or replace the existing subplant utilization data in the subplant utilization database. In other embodiments, the existing predicted subplant utilization data are supplemented with the updated subplant utilization data without replacing or overwriting the exiting subplant utilization data. For example, the existing subplant utilization data may be stored as a first version of the subplant utilization data and the updated subplant utilization data may be stored as a second version of the subplant utilization data. The subplant utilization database may store any number of versions of the subplant utilization data.

Still referring to FIG. 8, process 800 is shown to include prompting a user to select whether to display the updated subplant utilization data via the user interface (step 814). Step 814 may be performed in response to updating the stored subplant utilization data. For example, an update to the stored subplant utilization may occur while a user is viewing the dispatch GUI. When a new version of the subplant utilization data is stored in the subplant utilization database while the dispatch GUI is being viewed, the dispatch GUI may display a message indicating that a new version of data is available. The message may prompt the user to select whether to continue viewing the existing set of subplant utilization data (i.e., the set of subplant utilization data currently being displayed) or to switch to the most recent set of subplant utilization data.

If the user selects the existing set of subplant utilization data, the prompt may disappear and the dispatch GUI may continue displaying the existing subplant utilization data (step 818). However, if the user selects the updated subplant utilization data, the dispatch GUI may be regenerated to display the updated subplant utilization data (step 816). In some embodiments, if the user does not make a selection within a predetermined time period after the prompt is displayed, the dispatch GUI may automatically switch to displaying the most recent set of subplant utilization data (step 816). Advantageously, this feature may ensure that the dispatch GUI displays the most recent subplant utilization data when a user returns to the user interface after being away from the user interface for a period of time.

Still referring to FIG. 8, process 800 is shown to include receiving input from a user via the dispatch GUI (step 820) and generating and providing a control signal to the plurality of subplants based on the user input (step 822). In some embodiments, the dispatch GUI is part of a comprehensive user interface for monitoring and controlling the operation of central plant 200 and/or BAS 308. In some embodiments, the user input received via dispatch GUI overrides automated control decisions made by central plant controller 302. For example, the dispatch GUI may include interface options that allow a user to change the load setpoints for subplants 202-212, change the on/off states or operating setpoints for equipment 340, activate or deactivate entire subplants or individual devices of equipment 340, adjust the configuration of BAS 308 or central plant 200, or otherwise monitor and control the operation of central plant 200 and/or equipment 340. Step 822 may include controlling central plant 200 and/or equipment 340 (e.g., via actuators, power relays, etc.) in accordance with the user input received in step 820.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A system for visualizing equipment utilization in a central plant having a plurality of subplants configured to serve thermal energy loads, the system comprising:
a subplant monitor that receives subplant utilization data comprising an indication of a thermal energy load served by each of the plurality of subplants;
a subplant utilization database that receives the subplant utilization data from the subplant monitor and stores the subplant utilization data for each of a plurality of time steps; and
a dispatch graphical user interface (GUI) generator that retrieves the subplant utilization data from the subplant utilization database and generates a dispatch GUI using the subplant utilization data, the dispatch GUI comprising an indication of the thermal energy load served by each of the plurality of subplants for each of the plurality of time steps.

2. The system of claim 1, wherein the dispatch GUI generator causes the dispatch GUI to be displayed via a user interface of a client device.

3. The system of claim 1, wherein the dispatch GUI comprises a set of stacked bars for each of the time steps, each of the stacked bars representing the thermal energy load served by one of the subplants during a corresponding time step and having a size based on a magnitude of the thermal energy load.

4. The system of claim 3, wherein the dispatch GUI comprises:
a requested load line representing a total thermal energy load requested to be served by the plurality of subplants during each of the time steps; and
an excess load value indicating an amount by which a combined magnitude of the thermal energy loads represented by the stacked bars for a time step exceeds the requested thermal energy load for the time step.

5. The system of claim 1, wherein the dispatch GUI comprises:
a zero line;
a first set of stacked bars extending in a first direction from the zero line, each of the first set of stacked bars representing a cooling load served by a corresponding subplant configured to serve cooling loads; and
a second set of stacked bars extending in a second direction from the zero line opposite the first direction, each of the second set of stacked bars representing a heating load served by a corresponding subplant configured to serve heating loads.

6. The system of claim 1, wherein the subplant utilization data comprises:
actual subplant utilization data comprising an indication of a past or current thermal energy load served by each of the plurality of subplants; and
predicted subplant utilization data comprising a prediction of future thermal energy loads served by each of the plurality of subplants.

7. The system of claim 6, wherein the plurality of time steps comprise past time steps and future time steps;
wherein the subplant utilization database stores the actual subplant utilization data for the past time steps and stores the predicted subplant utilization data for the future time steps.

8. The system of claim 6, wherein the subplant utilization database receives a new prediction of the future thermal energy loads served by each of the plurality of subplants and updates the stored subplant utilization data with the new prediction of the future thermal energy loads.

9. The system of claim 1, wherein the thermal energy load comprises at least one of a heating load and a cooling load.

10. The system of claim 1, wherein the plurality of subplants comprise a thermal energy storage subplant that stores thermal energy produced by other of the subplants and serves the thermal energy load by discharging the stored thermal energy;
wherein the dispatch GUI comprises a thermal energy storage line representing a charge state for the thermal energy storage subplant during each of the time steps.

11. A method for visualizing equipment utilization in a central plant having a plurality of subplants configured to serve thermal energy loads, the method comprising:
receiving subplant utilization data comprising an indication of a thermal energy load served by each of the plurality of subplants;
storing, in a subplant utilization database, the subplant utilization data for each of a plurality of time steps; and
generating a dispatch graphical user interface (GUI) using the subplant utilization data, the dispatch GUI comprising an indication of the thermal energy load served by each of the plurality of subplants for each of the plurality of time steps.

12. The method of claim 11, further comprising causing the dispatch GUI to be displayed via a user interface of a client device.

13. The method of claim 11, wherein the dispatch GUI comprises a set of stacked bars for each of the time steps, each of the stacked bars representing the thermal energy load served by one of the subplants during a corresponding time step and having a size based on a magnitude of the thermal energy load.

14. The method of claim 13, wherein the dispatch GUI comprises:
a requested load line representing a total thermal energy load requested to be served by the plurality of subplants during each of the time steps; and
an excess load value indicating an amount by which a combined magnitude of the thermal energy loads represented by the stacked bars for a time step exceeds the requested thermal energy load for the time step.

15. The method of claim 11, wherein the dispatch GUI comprises:
a zero line;
a first set of stacked bars extending in a first direction from the zero line, each of the first set of stacked bars representing a cooling load served by a corresponding subplant configured to serve cooling loads; and
a second set of stacked bars extending in a second direction from the zero line opposite the first direction, each of the second set of stacked bars representing a heating load served by a corresponding subplant configured to serve heating loads.

16. The method of claim 11, wherein the subplant utilization data comprises:
actual subplant utilization data comprising an indication of a past or current thermal energy load served by each of the plurality of subplants; and
predicted subplant utilization data comprising a prediction of future thermal energy loads served by each of the plurality of subplants.

17. The method of claim 16, wherein the plurality of time steps comprise past time steps and future time steps;
wherein storing the subplant utilization data comprises storing the actual subplant utilization data for the past time steps and stores the predicted subplant utilization data for the future time steps.

18. The method of claim 16, further comprising:
receiving a new prediction of the future thermal energy loads served by each of the plurality of subplants; and
updating the stored subplant utilization data with the new prediction of the future thermal energy loads.

19. The method of claim 11, wherein the thermal energy load comprises at least one of a heating load and a cooling load.

20. The method of claim 11, wherein the plurality of subplants comprise a thermal energy storage subplant that stores thermal energy produced by other of the subplants and serves the thermal energy load by discharging the stored thermal energy;
wherein the dispatch GUI comprises a thermal energy storage line representing a charge state for the thermal energy storage subplant during each of the time steps.
